(19) United States
(12) Patent Application Publication
(10) Pub. No.: US 2025/0165754 A1
(43) Pub. Date: May 22, 2025

(54) PROCESSING TECHNIQUES FOR GENERATING, TRACKING, AND VISUALIZING ENVIRONMENTAL INSIGHTS

(71) Applicant: Lemu Global Limited, London (GB)

(72) Inventors: Leonardo Arturo Prieto Williamson, Frutillar (CL); Pablo Francisco Gonzalez Ordoñez, Frutillar (CL); Francisco José Galdames Grünberg, Santiago (CL)

(21) Appl. No.: 18/517,372

(22) Filed: Nov. 22, 2023

(51) Int. Cl. G06N 3/0475

(52) U.S. Cl. CPC G06N 3/0475

(57) ABSTRACT

Various embodiments of the present disclosure provide environmental modeling techniques for generating and presenting diverse sets of geographic insights for a geographic region. The geographic insights include landcover insights derived from hyperspectral data using machine learning techniques. The landcover insights include landcover predictions that correspond to geographic polygons and the machine learning techniques leverage models that are trained using hyperspectral image frames that correspond to labeled geographic polygons. The geographic insights include carbon stock insights derived from multiple static and dynamic rasters for a geographic region. The rasters include carbon zone, a landcover, a burned area, a soil carbon stock rasters, and the like, that may be aggregated according to a prediction scheme to generate time-dependent insights tailored to a particular point in time. These insights and others may be presented through specially designed overlays for a user interface.

### BACKGROUND

Traditionally, geographic insights, such as carbon stock insights, landcover predictions, species estimation, and the like, are manually generated using the latest information available to a particular research team. This leads to cherry-picked insights for areas of interest, while leaving other areas in obscurity. The generation of new insights, even for areas of interest that are associated with robust datasets, is resource intensive, time consuming, and dependent on the accuracy and reliability of the underlying data on which the insights are based. This makes traditional geographic insights unreliable, especially as data underpinning the insights becomes outdated. Moreover, traditionally, geographic studies are focused on a single type (e.g., landcover, carbon stock, species estimation, etc.) of insight. Once derived, the insight may be provided for visualization in isolation without context that could be provided by other types of geographic insights for a particular geographic area. As a result, traditional forms of geographic research must correlate data from a plurality of disparate data sources, each of which may have varying levels of accuracy, reliability, accessibility, and standardization.

Through applied effort and ingenuity, various technical problems associated with traditional environment modeling techniques have been solved through embodiments as discussed herein.

### BRIEF SUMMARY

Various embodiments are directed to automated environment modeling techniques that empower a unified interactive geographic graphical user interface (GUI) to present multiple, continuously updated, geographic insights for a plurality of geographic regions.

In some embodiments, a geographic prediction system comprises memory and one or more processors communicatively coupled to the memory, the one or more processors are configured to receive one or more hyperspectral image frames corresponding to at least a portion of a geographic region; generate, using one or more machine learning models, one or more landcover predictions for the geographic region based at least in part on the one or more hyperspectral image frames, wherein (i) the one or more landcover predictions correspond to one or more geographic portions within the geographic region, and (ii) the one or more machine learning models are trained using at least a plurality of historical hyperspectral image frames that correspond to one or more labeled geographic portions within one or more geographic regions; and initiate, through an interactive user interface, a presentation of the one or more landcover predictions to a user.

In some embodiments, the one or more processors are further configured to receive, through the interactive user interface, user input indicative of a selection of at least one of the one or more geographic portions within the geographic region; and generate, using the one or more machine learning models, the one or more landcover predictions for the geographic region in response to a determination that the at least one geographic portion is an unlabeled geographic portion.

In some embodiments, the interactive user interface comprises one or more selectable overlay icons and the presentation of the one or more landcover predictions is initiated in response to a selection of at least one of the one or more selectable overlay icons.

In some embodiments, a geographic portion of the geographic region comprises a geographic polygon or a georeferenced datapoint within the geographic region.

In some embodiments, the geographic polygon comprises a closed geographic area within the geographic region and a landcover prediction for the geographic polygon is indicative of an object class physically located within the closed geographic area.

In some embodiments, the object class is one or more of a type of vegetation species or a type of geographic environment.

In some embodiments, the interactive user interface reflects the geographic region and initiating the presentation of the one or more landcover predictions to the user comprises applying a landcover overlay over the one or more geographic portions within the geographic region and the landcover overlay comprises one or more masks that are fitted to the one or more geographic portions.

In some embodiments, the one or more geographic portions comprise one or more geographic polygons, the landcover overlay comprises one or more polygon masks that are fitted to the one or more geographic polygons, and each of the one or more polygon masks reflect an object class corresponding to a respective landcover prediction.

In some embodiments, each of the one or more masks comprises a class-specific color reflective of the object class corresponding to the respective landcover prediction.

In some embodiments, the one or more processors are further configured to receive, through the interactive user interface, user input indicative of a landcover label for a geographic portion within the geographic region; and in response to the user input, update the one or more labeled geographic portions within the one or more geographic regions.

In some embodiments, the user input is reflective of (i) a selection of a mask fitted over the geographic portion and (ii) a modification to a shape or an object class for the geographic portion.

In some embodiments, receiving, through the interactive user interface, the user input indicative of the landcover label for the geographic portion within the geographic region comprises receiving, through the interactive user interface, a drawing input reflective of a geographic polygon; and receiving, through the interactive user interface, a labeling input reflective of an object class for the geographic polygon.

In some embodiments, generating the one or more landcover predictions comprises inputting the one or more hyperspectral image frames to a feature reduction model to generate one or more three-channel image frames from the one or more hyperspectral image frames; and inputting the one or more three-channel image frames to a machine learning classification model to generate the one or more landcover predictions.

In some embodiments, a computer-implemented method comprises receiving, by one or more processors, one or more hyperspectral image frames corresponding to at least a portion of a geographic region; generating, by the one or more processors and using one or more machine learning models, one or more landcover predictions for the geographic region based at least in part on the one or more hyperspectral image frames, wherein (i) the one or more landcover predictions correspond to one or more geographic portions within the geographic region, and (ii) the one or more machine learning models are trained using at least a plurality of historical hyperspectral image frames that correspond to one or more labeled geographic portions within one or more geographic regions; and initiating, by the one or more processors and through an interactive user interface, a presentation of the one or more landcover predictions to a user.

In some embodiments, computer-implemented method comprises receiving, through the interactive user interface, user input indicative of a selection of at least one of the one or more geographic portion within the geographic region; and generating, using the one or more machine learning models, the one or more landcover predictions for the geographic region in response to a determination that the at least one geographic portion is an unlabeled geographic polygon.

In some embodiments, the interactive user interface comprises one or more selectable overlay icons and the presentation of the one or more landcover predictions is initiated in response to a selection of at least one of the one or more selectable overlay icons.

In some embodiments, a geographic portion of the geographic region comprises a geographic polygon or a georeferenced datapoint within the geographic region.

In some embodiments, the geographic comprises a closed geographic area within the geographic region and a landcover prediction for the geographic polygon is indicative of an object class physically located within the closed geographic area.

In some embodiments, the object class is one or more of a type of vegetation species or a type of geographic environment.

In some embodiments, a computer program product comprises a non-transitory computer readable medium having computer program instructions stored therein, the computer program instructions when executed by one or more processors, cause the one or more processors to receive one or more hyperspectral image frames corresponding to at least a portion of a geographic region; generate, using one or more machine learning models, one or more landcover predictions for the geographic region based at least in part on the one or more hyperspectral image frames, wherein: (i) the one or more landcover predictions correspond to one or more geographic portions within the geographic region, and (ii) the one or more machine learning models are trained using at least a plurality of historical hyperspectral image frames that correspond to one or more labeled geographic portions within one or more geographic regions; and initiate, through an interactive user interface, a presentation of the one or more landcover predictions to a user.

In some embodiments, a geographic prediction system includes memory and one or more processors communicatively coupled to the memory. The one or more processors are configured to receive a carbon zone raster for a geographic region based at least in part on a plurality of global vectors, wherein the carbon zone raster is indicative of a plurality of regional features for the geographic region; receive a landcover raster for the geographic region, wherein the landcover raster is indicative of a plurality of landcover predictions for the geographic region; generate an initial carbon value raster for the geographic region based at least in part on the landcover raster, the carbon zone raster, and a plurality of carbon lookup tables, wherein the initial carbon value raster includes a plurality of initial georeferenced carbon datapoints corresponding to the geographic region; generate a reduced carbon raster based at least in part on a comparison between the initial carbon value raster and a burned area raster corresponding to the geographic region; generate a carbon stock raster by aggregating the reduced carbon raster with a soil carbon stock raster corresponding to the geographic region, wherein the carbon stock raster includes a plurality of refined georeferenced carbon datapoints corresponding to the geographic region; and initiate, through an interactive user interface, a presentation of the carbon stock raster relative to the geographic region.

In some examples, the interactive user interface includes one or more selectable overlay icons and the presentation of the carbon stock raster is initiated in response to a selection of a first selectable overlay icon of the one or more selectable overlay icons.

In some examples, each of the one or more selectable overlay icons corresponds to a respective georeferenced overlay of one or more georeferenced overlays that include a carbon stock overlay corresponding to the carbon stock raster and a landcover overlay corresponding to the plurality of landcover predictions.

In some examples, the interactive user interface includes a map interface reflective of one or more geographic regions that include the geographic region and initiating the presentation of the carbon stock raster includes receiving user input indicative of a selection of the geographic region; and in response to the user input, applying the carbon stock overlay over the geographic region, wherein the carbon stock overlay includes a plurality of pixel values that correspond to the plurality of refined georeferenced carbon datapoints of the carbon stock raster.

In some examples, the plurality of carbon lookup tables is associated with a table resolution and the one or more processors are further configured to align the landcover raster and the carbon zone raster with the table resolution.

In some examples, generating the initial carbon value raster includes generating a plurality of geographic landcover datapoints for the geographic region by scaling the plurality of landcover predictions of the landcover raster based at least in part on the table resolution; generating a regional-landcover pair for a geographic landcover datapoint of the plurality of geographic landcover datapoints by matching the geographic landcover datapoint to at least one regional feature of the plurality of regional features from the carbon zone raster; identifying, using the plurality of carbon lookup tables, a carbon value for the geographic landcover datapoint based at least in part on the regional-landcover pair; and generating an initial georeferenced carbon datapoint of the plurality of initial georeferenced carbon datapoints based at least in part on the carbon value.

In some examples, the burned area raster is generated by receiving a geographic raster corresponding to the geographic region, wherein the geographic raster includes a plurality of georeferenced datapoints; identifying one or more burned datapoints of the plurality of georeferenced datapoints that correspond to one or more burned areas within the geographic region, wherein the one or more burned areas are based at least in part on one or more historical burn records; and generating the burned area raster by assigning a weighting value to each of the one or more burned datapoints.

In some examples, the weighting value is configured to reduce a value associated with an initial georeferenced carbon datapoint by a predetermined percentage.

In some examples, the reduced carbon raster includes a plurality of reduced georeferenced carbon datapoints and generating the carbon stock raster includes receiving the soil carbon stock raster for the geographic region, wherein the soil carbon stock raster includes a plurality of georeferenced soil carbon datapoints; identifying a georeferenced soil carbon datapoint of the plurality of georeferenced soil carbon datapoints that corresponds to a reduced georeferenced carbon datapoint of the plurality of reduced georeferenced carbon datapoints; and generating a refined georeferenced carbon datapoint of the plurality of refined georeferenced carbon datapoints based at least in part on an addition of the georeferenced soil carbon datapoint to the reduced georeferenced carbon datapoint.

In some examples, the carbon zone raster includes a plurality of georeferenced regional datapoints that are aggregated from a plurality of region classifications for each of the plurality of global vectors.

In some examples, the plurality of global vectors includes at least one of a continental region vector, an eco-florist region vector, or a forest frontier region vector and the plurality of regional features are indicative of a continental classification, an eco-florist classification, or a frontier classification for one or more portions of the geographic region.

In some examples, the plurality of global vectors, the landcover raster, the burned area raster, or the soil carbon stock raster are based at least in part on a selected time parameter.

In some embodiments, a computer-implemented method includes receiving, by one or more processors, a carbon zone raster for a geographic region based at least in part on a plurality of global vectors, wherein the carbon zone raster is indicative of a plurality of regional features for the geographic region; receiving, by the one or more processors, a landcover raster for the geographic region, wherein the landcover raster is indicative of a plurality of landcover predictions for the geographic region; generating, by the one or more processors, an initial carbon value raster for the geographic region based at least in part on the landcover raster, the carbon zone raster, and a plurality of carbon lookup tables, wherein the initial carbon value raster includes a plurality of initial georeferenced carbon datapoints corresponding to the geographic region; generating, by the one or more processors, a reduced carbon raster based at least in part on a comparison between the initial carbon value raster and a burned area raster corresponding to the geographic region; generating, by the one or more processors, a carbon stock raster by aggregating the reduced carbon raster with a soil carbon stock raster corresponding to the geographic region, wherein the carbon stock raster includes a plurality of refined georeferenced carbon datapoints corresponding to the geographic region; and initiating, by the one or more processors through an interactive user interface, a presentation of the carbon stock raster relative to the geographic region.

In some examples, the interactive user interface includes one or more selectable overlay icons and the presentation of the carbon stock raster is initiated in response to a selection of a first selectable overlay icon of the one or more selectable overlay icons.

In some examples, each of the one or more selectable overlay icons corresponds to a respective georeferenced overlay of one or more georeferenced overlays that include a carbon stock overlay corresponding to the carbon stock raster and a landcover overlay corresponding to the plurality of landcover predictions.

In some examples, the interactive user interface includes a map interface reflective of one or more geographic regions that include the geographic region and initiating the presentation of the carbon stock raster includes receiving user input indicative of a selection of the geographic region; and in response to the user input, applying the carbon stock overlay over the geographic region, wherein the carbon stock overlay includes a plurality of pixel values that correspond to the plurality of refined georeferenced carbon datapoints of the carbon stock raster.

In some examples, the plurality of carbon lookup tables is associated with a table resolution and the one or more processors are further configured to align the landcover raster and the carbon zone raster with the table resolution.

In some embodiments, a computer program product comprising a non-transitory computer readable medium having computer program instructions stored therein, the computer program instructions when executed by one or more processors, cause the one or more processors to receive a carbon zone raster for a geographic region based at least in part on a plurality of global vectors, wherein the carbon zone raster is indicative of a plurality of regional features for the geographic region; receive a landcover raster for the geographic region, wherein the landcover raster is indicative of a plurality of landcover predictions for the geographic region; generate an initial carbon value raster for the geographic region based at least in part on the landcover raster, the carbon zone raster, and a plurality of carbon lookup tables, wherein the initial carbon value raster includes a plurality of initial georeferenced carbon datapoints corresponding to the geographic region; generate a reduced carbon raster based at least in part on a comparison between the initial carbon value raster and a burned area raster corresponding to the geographic region; generate a carbon stock raster by aggregating the reduced carbon raster with a soil carbon stock raster corresponding to the geographic region, wherein the carbon stock raster includes a plurality of refined georeferenced carbon datapoints corresponding to the geographic region; and initiate, through an interactive user interface, a presentation of the carbon stock raster relative to the geographic region.

In some examples, a carbon zone raster includes a plurality of georeferenced regional datapoints that are aggregated from a plurality of region classifications for each of the plurality of global vectors.

In some examples, the plurality of global vectors includes at least one of a continental region vector, an eco-florist region vector, or a forest frontier region vector and the plurality of regional features are indicative of a continental classification, an eco-florist classification, or a frontier classification for one or more portions of the geographic region.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a system diagram showing example devices for facilitating an automated environment modeling technique in accordance with some embodiments discussed herein.

FIG. 4 is a dataflow diagram showing example data structures and modules for facilitating an automated environment modeling technique in accordance with some embodiments discussed herein.

FIG. 5 is a dataflow diagram showing an example multi-stage image classification process in accordance with some embodiments discussed herein.

FIG. 6 is an example training input data object in accordance with some embodiments discussed herein.

FIG. 7 is an example interactive geographic GUI in accordance with some embodiments discussed herein.

FIG. 8 is an example carbon classification process is a dataflow diagram showing an example multi-stage carbon classification process in accordance with some embodiments discussed herein.

FIGS. 9A-C are example global vectors in accordance with some embodiments discussed herein.

FIGS. 10A-C are example input rasters in accordance with some embodiments discussed herein.

FIG. 11 is an example carbon stock overlay in accordance with some embodiments discussed herein.

FIG. 12 is an example species overlay in accordance with some embodiments discussed herein.

FIG. 13 is a flowchart showing an example of a process for generating one or more landcover predictions in accordance with some embodiments discussed herein.

FIG. 14 is a flowchart showing an example of a process for generating one or more carbon stock values in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

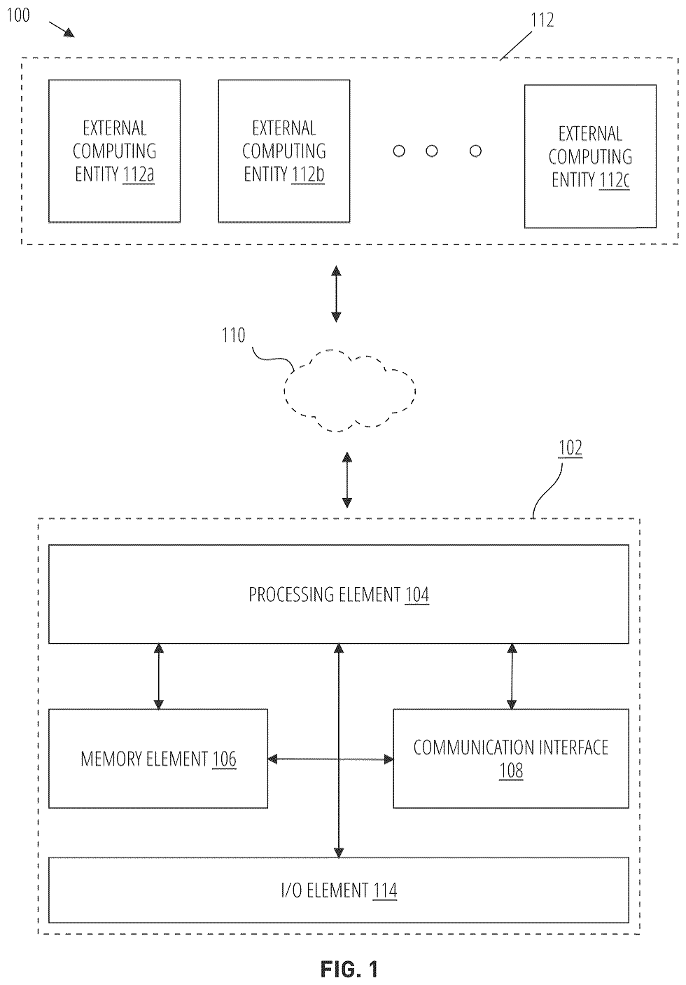

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may include a geographic prediction system that may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., prediction techniques, machine learning techniques, classification techniques, training techniques, and/or the like) described herein.

The external computing entities 112a-c, for example, may include and/or be associated with one or more data source entities, user computing entities, and/or the like. The data source entities may be configured to receive, store, manage, and/or facilitate one or more datasets that may be accessible to the predictive computing entity. For instance, the data source entities may be configured to receive, store, manage, and/or facilitate one or more portions of an image datastore that includes labeled training data, historical image data, hyperspectral and/or three-channel images, and/or the like. In addition, or alternatively, the data source entities may be configured to receive, store, manage, and/or facilitate one or more portions of a landcover dataset that includes labeled geographic regions, and/or the like. In some examples, the data source entities may be configured to receive, store, manage, and/or facilitate one or more input rasters, such as landcover rasters, burned area rasters, soil carbon stock rasters, and/or the like. In some examples, the data source entities may be configured to receive, store, manage, and/or facilitate one or more global vectors. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a prediction domain.

In addition, or alternatively, the external computing entities 112a-c may include one or more user devices, such as one or more laptops, mobile devices, desktop computers, and/or the like. The external computing entities 112a-c, for example, may be individually and/or collectively leveraged by the predictive computing entity 102 to present information to a user and/or receive user input.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways to (i) generate one or more predictions, such as the landcover predictions, carbon stock prediction, species prediction, and/or the like as described herein, (ii) provide various overlays, (iii) training one or more machine learning models, and/or the like. The predictive computing entity 102 may be configured for a particular use or configured to execute instructions stored in volatile or non-volatile media or otherwise accessible to the processing element 104 to (i) generate one or more predictions, such as the landcover predictions, carbon stock prediction, species prediction, and/or the like as described herein, (ii) provide various overlays, (iii) training one or more machine learning models, and/or the like. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

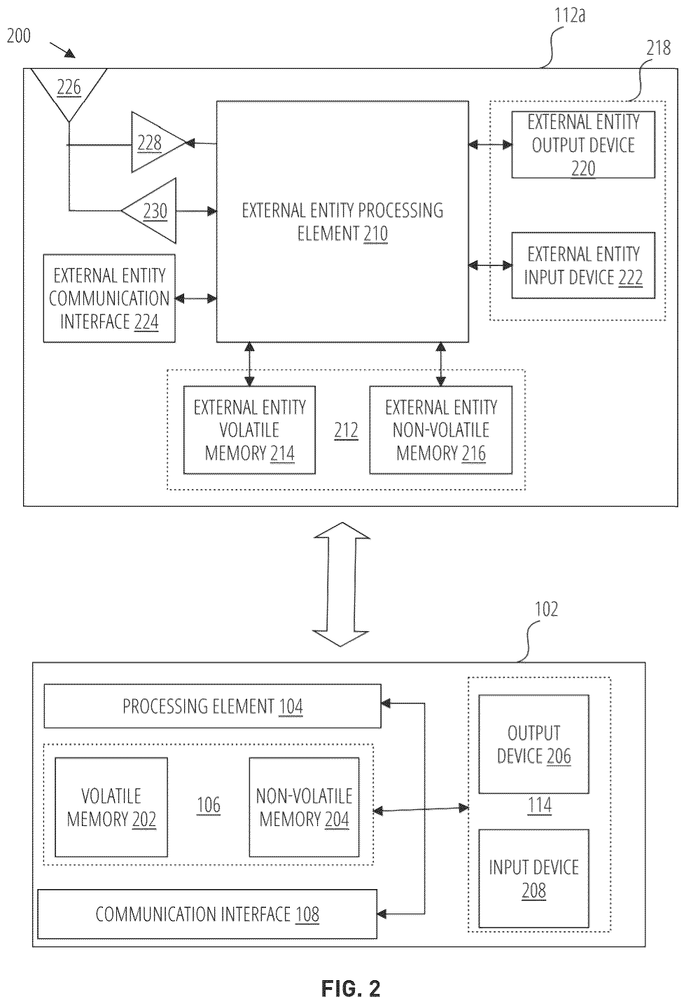

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, location data including latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. OVERVIEW

Embodiments of the present disclosure present improved machine learning techniques that improve computer interpretation of hyperspectral imagery. To do so, the present disclosure provides a machine learning model pipeline that leverages deep geographic insights from hyperspectral imagery, while allowing the model to be trained on human interpretable, three-channel imagery. The machine learning model pipeline, for example, may include a feature reduction model and a classification model. The feature reduction model may be configured to reduce a hyperspectral image frame to a three-channel image frame that is representative of the dense hyperspectral information from the hyperspectral image frame. The classification model may be trained, using labeled three-channel image frames, to generate predictive insights for a geographic region. In this way, a machine learning classification model may be trained to leverage hyperspectral image information using insights that may be manually generated. When combined with the feature reduction model, the machine learning classification model forms an improved image processing pipeline that is capable of automatically generating geographical predictions for the geographic area using hyperspectral imagery. This, in turn, allows for comprehensive, on-demand, prediction techniques that may automatically generate, monitor, and present geographic insights for a geographic region using hyperspectral image frames captured over time. By doing so, some of the techniques of the present disclosure present improved image processing techniques that may be practically applied for any number of different use cases to generate accurate, time-based predictions for a geographic area based at least in part on accessible hyperspectral image frames. One such use case, for example, may include an on-demand landcover prediction scheme for generating granular landcover predictions, in real time, for any geographic area based at least in part on user input.

Embodiments of the present disclosure present improved prediction schemes for automatically generating geographic insights, such as carbon predictions, for a geographic region. To do so, the present disclosure provides predictive techniques that augment historical insights with time-based data to generate granular geographic insights that are tailored to the features of a geographic region at a particular point in time while accounting for the region's history. At least a portion of the historical insights may be obtained from satellite-imaging data, localized imaging data, and/or the like, and the time-based data may be generated from one or more additional data sources. The predictive techniques may include a three-phase approach that combines time-dependent (i) landcover classifications, such a landcover predictions, and (ii) burned area information with historical carbon stock predictions to generate a time-dependent (e.g., current, historical, etc.) carbon stock prediction for a geographic area. In this manner, historical insights may be tailored, using time-dependent data, to a particular point in time to generate geographic insights for a geographic region at that particular point in time. This enables the automatic classification of geographic areas that leverage up to date landcover predictions for an area without ignoring previously recorded historical evidence. By doing so, some of the techniques of the present disclosure present improved prediction techniques that may be practically applied for any number of different use cases to generate accurate, time-based predictions for a geographic area by intelligently merging static and dynamic data. One such use case, for example, may include an on-demand carbon stock prediction scheme for generating granular carbon stock predictions, in real time, for any geographic area based at least in part on user input. Such granular predictions may be compiled and analyzed over time to detect and monitor previously undetectable changes in an environment.

Embodiments of the present disclosure present improved user interfaces for surfacing diverse and time-dependent geographic insights for a geographic region to a user. The user interfaces may be leveraged by mobile devices in communication with an image processing system that enables a user to select between a plurality of geographic overlays for a geographic region to view, in real time, different current and historical geographic insights for the geographic region. The user interface leverages a plurality of specially designed geographic overlays and input mechanisms to extract user input and, based at least in part on the user input, present easily interpretable data for consumption by the user. Each of the specially designed geographic overlays may be derived from predictions for the geographic region and may present previously undetectable insights to the user. The user interface may enable graphical sequencing of the overlays to visualize changes to a geographic region over time and across a diverse set of geographic attributes. The improved user interfaces for electronic devices may be practically applied for any number of different use cases to generate accurate, time-based visualizations for a geographic area to improve a user's accessibility to geographic information over traditional geographic interfaces. Ultimately, the automated systems of the present disclosure leverage new user interface designs and sequences to enable real-time access to at least landcover classifications, carbon stock classification, and species predictions for a geographic region, which is unattainable by traditional computing systems.

Examples of technologically advantageous embodiments of the present disclosure include: (i) a machine learning model pipeline for interpreting hyperspectral imagery and classifying geographic regions within the hyperspectral imaging; (ii) a predictive scheme for automatic, time-based carbon predictions for automatically identified regions within images; (iii) comprehensive user interfaces, among other aspects of the present disclosure. Other technical improvements and advantages may be realized by one of ordinary skill in the art.

### IV. EXAMPLE SYSTEM OPERATIONS

As indicated, various embodiments of the present disclosure make important technical contributions to machine learning and geographic monitoring technologies. In particular, systems and methods are disclosed herein that implement machine learning techniques and machine learning models for interpreting hyperspectral image frames. Unlike traditional machine learning techniques, the machine learning models may be trained using ground truth information corresponding to three-channel representations of hyperspectral images. This, in turn, allows training data to be crowdsourced across a plurality of different users based at least in part on user interpretable information, while training a model to leverage deep geographical features provided by hyperspectral imagery.

Moreover, using some of the techniques of the present disclosure, geographical boundaries may be intelligently identified to segment geographic regions into geographic units (e.g., polygons, etc.) of information to provide fine grained insights into various previously undetectable geographic discrepancies. In this manner, various land characteristics, such as landcover predictions, carbon stock predictions, species predictions, and/or the like, may be complied from granular portions of an environment by combining highly localized data together with large scale observations (e.g., satellite imagery). By doing so, new geographic insights (e.g., geographical boundaries applicable to various land characteristics, an edge of a high- or low-carbon stock region, a correlation between landcover, carbon stock, and species populations, and/or the like) may be derived that are learned across a plurality of traditionally disparate geographic regions and data types. For example, using some of the techniques of the present disclosure, the geographic relevance of granular, highly localized data, such as species predictions, may be extrapolated, with large scale carbon stock and landcover predictions, to estimate a likelihood of species in disparate geographic regions.

These and other benefits may be achieved through the use of certain data input mechanisms that enable one or more machine learning models to input data with otherwise incompatible formats, and through the use of a single machine learning model, or a pipeline of machine learning models that operate together, to provide the data output results as discussed herein.

### A. Landcover Predictions

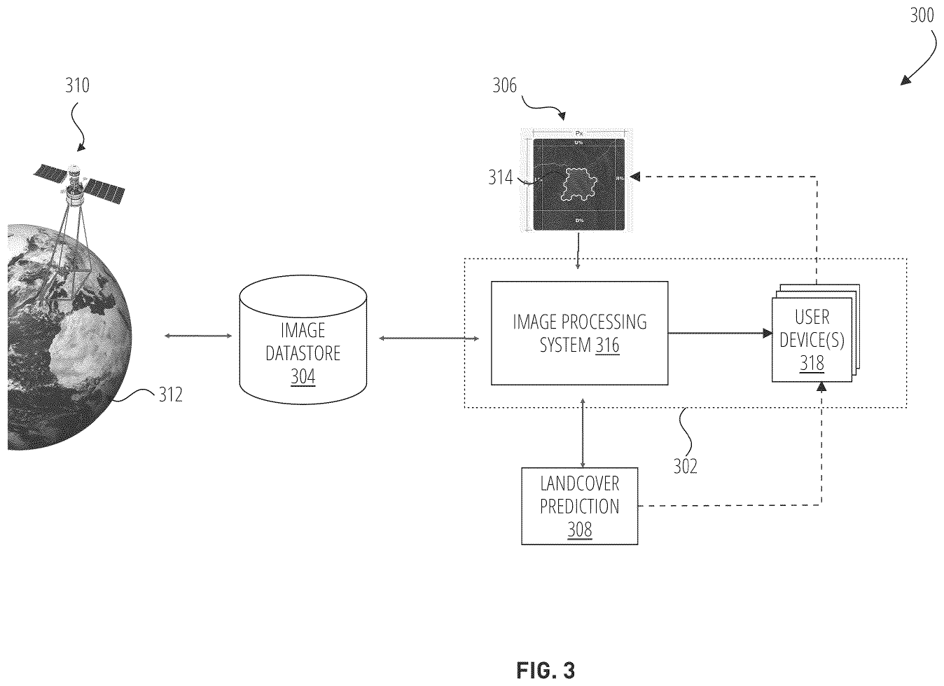

FIG. 3 is a system diagram 300 showing an example computing ecosystem for facilitating an automated environment modeling technique in accordance with some embodiments discussed herein. The system diagram 300 depicts a geographic prediction system 302 in communication with an image datastore 304 that stores a plurality of image frames of an environment 312. The image frames, for example, may include satellite imagery captured using one or more satellites 310. In some examples, using some of the automated environment modeling techniques of the present disclosure, the geographic prediction system 302 may leverage insights from the image datastore 304 to automatically generate landcover predictions 308 for a geographic region 306 within the environment 312. In some examples, the landcover prediction 308 may correspond to a geographic polygon 314, a geographic datapoint, and/or the like within the geographic region 306.

In some embodiments, the geographic prediction system 302 is a computing system configured to perform one or more operations of an automated environment modeling technique. The geographic prediction system 302 may include one or more memories and/or one or more processors communicatively coupled to at least one of the memories and configured to perform one or more aspects of the automated environment modeling techniques of the present disclosure. For example, the geographic prediction system 302 may be an example computing system (e.g., computing system 100) that is configured to process one or more image frames, generate, provide, and/or receive one or more landcover predictions 308 for the one or more image frames, generate, provide, and/or receive a landcover overlay based at least in part on the landcover predictions 308, and/or any other environment modeling operations, such as those described herein.

In some embodiments, the geographic prediction system 302 includes an image processing system 316 in communication with a plurality of user devices 318. The image processing system 316, for example, may be configured to provide a software application that is accessible to the plurality of user devices 318 (e.g., over one or more networks, etc.). In this manner, the user devices 318 may access, through interaction with the image processing system 316, an interactive geographic GUI. In some examples, one or more users may interact with the interactive geographic GUI to view a geographic region 306, select a geographic polygon 314 within the geographic region 306, view a landcover overlay reflective of landcover predictions 308 for the geographic region 306 (and/or geographic polygon 314 thereof), and/or the like.

In some embodiments, the geographic prediction system 302 is configured to generate a landcover prediction 308 for a geographic polygon 314 within a geographic region 306. In some embodiments, the geographic region 306 is a geographic area that is reflected by a user interface, an image frame, and/or any other representation. The geographic region 306, for example, may correspond to a physical location on the Earth's surface (or any other environment 312). The size of the geographic region 306 may be dynamically determined by the user interface, image angle, and/or the like. In some examples, the geographic region 306 may form a base layer of a graphical output provided by an interactive geographic GUI. In some examples, a georeferenced overlay (e.g., a landcover overlay, etc.) may form a second layer over the geographic region.

In some embodiments, a geographic polygon 314 is a closed portion within the geographic region 306. The geographic polygon 314, for example, may be defined by location coordinates that define a border within the geographic region 306. A geographic polygon 314 may be included in any of a number of geographic regions and is not limited to a single geographic region. In some examples, the geographic polygon 314 may be defined within a keyhole markup language (KML) data structure.

In some examples, the geographic polygon 314 may include an unlabeled geographic polygon and/or a labeled geographic polygon. An unlabeled geographic polygon may include a closed portion within the geographic region 306 that is unclassified. For instance, an unlabeled geographic polygon may be identified by a user and, using some of the techniques of the present disclosure, labeled to generate a labeled geographic polygon. A labeled geographic polygon may include a closed portion within a geographic region that is classified with a landcover label. The landcover label, for example, may include a landcover prediction 308 generated for the geographic polygon 314. In other embodiments, one or more models as discussed herein may be configured to generate one or more polygons (at least in part by identifying the location of boundaries of the polygon in one or more images and the location of those boundaries may be assigned geographic coordinates to enable these boundaries to be cross-referenced across different images), such as unlabeled polygons or labeled polygons. As discussed in greater detail herein, these polygons may be identified based at least in part on one or more characteristics identified within one or more images, such as visible characteristics (e.g., differences in color in one or more images) or non-visible characteristics (e.g., determined relationships among characteristics in multiple images).

In some embodiments, a landcover prediction 308 is an output of the image processing system 316. The landcover prediction 308 may include a landcover label for a geographic portion within a geographic region. The geographic portion may include a georeferenced datapoint and/or a geographic polygon 314 that is predicted based at least in part on one or more features of the geographic portion. The landcover prediction 308 may include a binary classification indicative of an assignment of a landcover label to the geographic portion. In addition, or alternatively, a landcover prediction 308 may be indicative of a probability (e.g., a number between 0 and 1) that a landcover label corresponds to the geographic portion. By way of example, a landcover prediction 308 may include a landcover label and/or a confidence score for the landcover label.

In some embodiments, a landcover label is a data entity that describes an object class for a geographic portion of a geographic area. For example, the landcover label may correspond to a geographic polygon 314 and/or a georeferenced datapoint. An object class may be indicative of any type of object, including one or more types of a vegetation species, one or more types of geographic environments (e.g., lakes, rocks, snow, urban, etc.), one or more types of agriculture environments, and/or the like. In some examples, an object class may identify a particular tree species physically present in a geographic area outlined by the geographic polygon 314. In addition, or alternatively, an object class may correspond to one or more landcover classifications leveraged by one or more carbon lookup tables. By way of example, an object class may include one or more global landcover classes (e.g., as GLC2000 class, etc.), such as artificial surfaces and associated areas, bare areas, cultivated and managed areas, herbaceous cover, mosaic, shrub cover, and/or the like.

In some embodiments, the geographic prediction system 302 is configured to generate the landcover prediction 308 indicative of a landcover label for the geographic polygon 314 based at least in part one or more image frames within the image datastore 304. The image datastore 304, for example, may include a plurality of image frames of one or more different image types and collected over one or more different time periods.

In some embodiments, an image frame is a plurality of pixels (e.g., spatial, spectral, etc.) with one or more feature channels. For example, an image frame may include a single channel image frame, such as grayscale image frame, a three-channel image frame, such as a red, green, blue (RGB) image frame, and/or a hyperspectral image frame including hundreds of feature channels at different frequency spectra. In some examples, the geographic region 306 (and/or geographic polygon 314 therein) may be represented by a plurality of different image frames from the image datastore 304. The plurality of different image frames may include different numbers of channels and/or may correspond to one or more different times. By way of example, the geographic region 306 may be represented by a three-channel image, such as an RGB image frame, that has three-channels: red, green, and blue that roughly follow the color receptors in a human eye. In some examples, the geographic region 306 may be represented through an interactive geographic GUI as a three-channel image frame. As another example, the geographic region 306 may be represented by a hyperspectral image frame with three-dimensional pixels representing a spectral curve filtered from a series of spectral bands. In some examples, the hyperspectral image frames may be leveraged to derive one or more insights, such as landcover predictions, for the geographic region 306 that may be surfaced through overlay, such as a landcover overlay, over a three-channel image frame. In some examples, the image datastore 304 may include a plurality of hyperspectral image frames across a plurality of time ranges that enable the generation of insights (e.g., trends, time lapses, predictive monitoring, etc.) over different time periods.

In some embodiments, an image frame is reflective of a geographic region 306 within an environment 312. For instance, an image frame may include a satellite image captured by one or more satellites 310 as the satellites 310 rotate around the environment 312. The satellites 310, for example, may include geospatial satellites, such as one or more Landsat satellites. Each of the satellites 310 may be configured to capture geographical features within the geographic region 306 through single to multi-channel image frames. For instance, the satellites 310 may include circuitry configured to generate RGB image frames for a portion of the environment 312. As another example, the satellites 310 may include hyperspectral satellites with circuitry configured to generate hyperspectral image frames for a portion of the environment 312.

In some embodiments, the image datastore 304 may include a plurality of historical and/or current image frames corresponding to a plurality of time periods. For example, the image frames for the geographic region 306 may include a plurality of three-channel and/or hyperspectral image frames captured and stored over one or more time periods. The one or more time periods, for example, may correspond to an orbit of the satellites 310 around the environment 312.

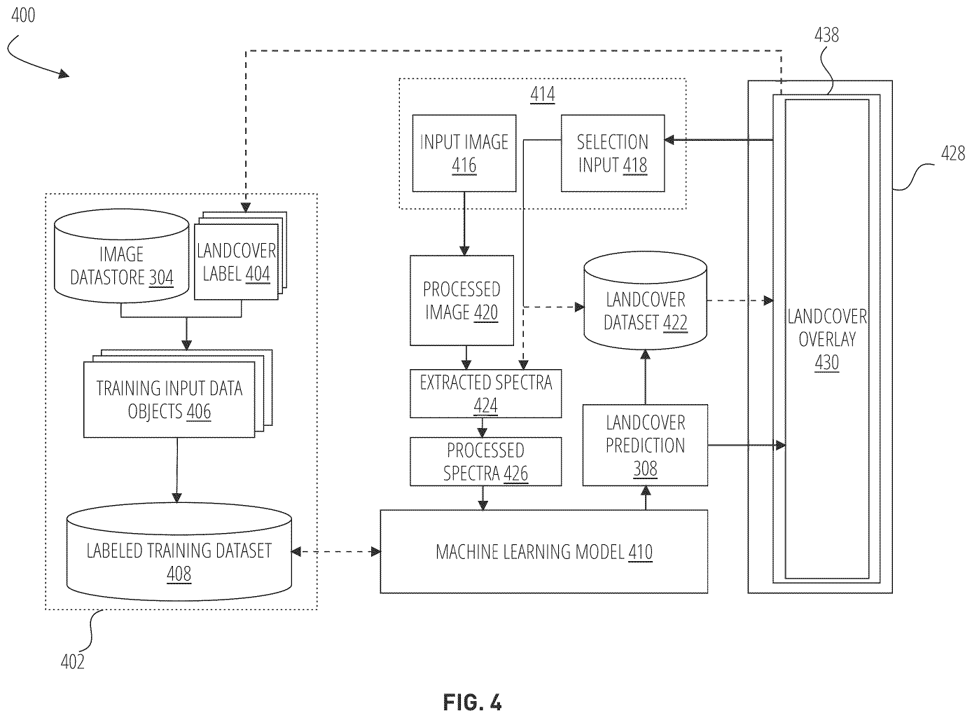

In some embodiments, machine learning techniques are leveraged to merge in dense pixel-level insights provided by hyperspectral image frames with manual labels provided through interpretable three-channel image frames. For example, the geographic region 306 may be associated with multiple different image frames of varying channels from the image datastore 304. Information, such as labels, that are provided for the geographic region represented by the three-channel image frame may be correlated to a hyperspectral image frame using the machine learning techniques and common geographic coordinates shared across the georeferenced image frames. In addition, or alternatively, hyperspectral image frames may be converted to three-channel image frames using feature reduction methods, such as those implemented by a feature reduction model. In some examples, these machine learning techniques may be leveraged to generate the landcover prediction 308. An example of a process for generating the landcover prediction 308 will now further be described with reference to FIG. 4.

FIG. 4 is a dataflow diagram 400 showing example data structures and modules for facilitating an automated environment modeling technique in accordance with some embodiments discussed herein. The dataflow diagram 400 depicts an interactive geographic GUI 428 configured to receive and/or provide data for generating one or more landcover predictions. The landcover predictions, for example, may be presented by the interactive geographic GUI 428 as a landcover overlay 430. In some examples, the landcover predictions may be generated using a machine learning model 410 previously trained using training data 402. In some embodiments, the geographic prediction system 302 may be configured to leverage the trained machine learning model 410 to generate the landcover predictions 308.

In some embodiments, the machine learning model 410 is configured to generate landcover predictions 308 based at least in part on the input data 414. The input data 414, for example, may include one or more input images 416, a selection input 418, and/or image metadata for the input images 416. For example, the input images 416 may include one or more hyperspectral image frames encompassing an image of at least a portion of the geographic region (e.g., from a satellite perspective, from an aircraft perspective, from a ground-vehicle perspective, from a ground level perspective, and/or the like). The image metadata may include one or more contextual attributes for the image, such as a height of one or more clouds, weather, temperature, time of day, and/or the like, associated with the geographic region as captured by a hyperspectral image. In some examples, the selection input 418 may correspond to one or more geographic polygons within the geographic region. For example, selection input may be received, through the interactive geographic GUI 428, that is indicative of a selection of at least one of one or more geographic polygons within the geographic region. For instance, the interactive geographic GUI 428 may present an interactive map interface 438. In some examples, the selection input 418 may outline (e.g., through one or selection tools, drawing tools, etc.) a geographic polygon within a geographic region reflected by the map interface 438.

In some embodiments, the landcover prediction 308 corresponds to a geographic polygon identified by the selection input. The geographic polygon, for example, may include a closed portion within the geographic region. The landcover prediction 308 for the geographic polygon may be indicative of an object class physically located within the closed geographic area. The object class, for example, may be one or more of a type of vegetation species, a type of geographic environment, and/or the like.

In some embodiments, one or more landcover predictions 308 are generated, using the machine learning model 410, for the geographic region based at least in part on the one or more input images 416. The input image 416, for example, may include one or more hyperspectral image frames corresponding to the geographic region. In some examples, the one or more landcover predictions 308 may be generated for the geographic region in response to a determination that at least one geographic polygon within the geographic region is an unlabeled geographic polygon.

For example, a geographic polygon may be previously labeled using one or more manual and/or predictive labeling techniques to generate a labeled geographic polygon. Labeled geographic polygons may be stored in a landcover dataset 422 to allow for the retrieval of previously determined landcover labels for a geographic polygon. In some examples, in response to a selection input 418 indicative of a geographic polygon, the geographic polygon may be compared with landcover dataset 422 to identify whether a landcover label for the geographic polygon is available. In some examples, an availability of a landcover label may be based at least in part a timing parameter. For instance, a landcover label may correspond to a particular time (e.g., a time at which the landcover label is generated, etc.). In some examples, a landcover label may be available if the timing parameter is below a threshold (e.g., a year, a month, one or more days, etc.). In some embodiments, the timing parameter is manually set by a user.

In some embodiments, the landcover dataset 422 is a data entity that includes a plurality of labeled geographic polygons. The landcover dataset 422, for example, may include a plurality of geographic polygons, a plurality of landcover labels, and/or a plurality of associations between the landcover labels and the geographic polygons. The plurality of associations may be indicative of a plurality of ground truth landcover labels (e.g., verified, manually entered, etc.) and/or landcover predictions for the plurality of geographic polygons. In some examples, the geographic polygons and/or landcover labels may be defined KML data structures. For instance, a KML data structure may define a geographic polygon and a landcover label corresponding to the geographic polygon.

In some embodiments, the landcover dataset 422 is continuously augmented and refined using machine learning techniques, user input, and/or georeferenced image frames. For example, using some of the techniques of the present disclosure, geographic polygons may be identified and labeled in image frames reflective of a geographic region. As described herein, machine learning techniques may be leveraged to learn insights from labeled geographic polygons at multiple feature channels to automatically identify and label new or changing geographic regions as reflected by new or modified representations of a geographic region.

For example, in the event that a landcover label is available for a selected geographic polygon, the landcover label may be retrieved and leveraged to generate a landcover overlay 430 over a geographic region reflected by the map interface 438 of the interactive geographic GUI. An available landcover label may be determined based at least in part on data stored for the polygon (e.g., a label previously generated for the polygon) or based at least in part on data stored for at least a portion of the geographic region contained within the polygon. Certain embodiments may utilize one or more models to determine whether a label attributed to a portion of the geographic region contained within the polygon should be attributed to the polygon as a whole (e.g., based at least in part on a determination of the percentage of the polygon that is contained within a previously labeled region and/or based at least in part on other characteristics of the polygon and the previously labeled subregion within the polygon). In the event that the landcover label is not available, input images 416 corresponding to the geographic polygon may be leveraged to generate the landcover prediction 308.

In some embodiments, the one or more input image 416 are preprocessed to generate a processed image 420 for the at least one geographic polygon within the geographic region. The input image 416, for example, may be processed using one or more image processing techniques, such as spatial scale adjustment techniques, spectra filtering techniques (e.g., filtering of spectra taking into account the neighborhood, etc.), noise reduction techniques, object detection and/or removal techniques (e.g., identification or clouds, etc.), brightness correction techniques (e.g., identification of shadowed areas, etc.), and/or the like. For example, the input image 416 may be preprocessed using one or more noise reduction techniques, such as a Gaussian filter, median filter, Weiner filter, and/or the like, to generate the processed image 420.

In some embodiments, the processed image 420 is compared with the selection input 418 to generate extracted spectra 424. For example, the extracted spectra 424 may include a plurality of pixels with pixel values corresponding to one or more frequency distributions from a hyperspectral image frame. For example, the extracted spectra 424 may include hyperspectral information (e.g., three-dimensional frequency data) for each geographic coordinate within the geographic polygon.

In some embodiments, the extracted spectra 424 is processed to generate a processed spectra 426 for the geographic region. The processed spectra 426, for example, may include a representation of the extracted spectra 424 at a reduced dimensionality. For example, the extracted spectra 424 may include a portion of a hyperspectral image frame. The processed spectra 426 may include three-channel information corresponding to the portion of the hyperspectral image frame. By way of example, an artificial neural network and/or other feature reduction method may be leveraged to generate a three-channel image frame from the portion of the hyperspectral image frame. In some examples, the three-channel image frame may be generated using a feature reduction model.

In some embodiments, the processed spectra 426 is input to the machine learning model 410 to generate one or more landcover predictions 308 for the geographic polygon. In some examples, a presentation of the one or more landcover predictions 308 may be initiated, through the interactive geographic GUI 428. The landcover predictions 308, for example, may be presented by applying the landcover overlay 430 over the geographic region reflected by the map interface 438 within the interactive geographic GUI 428.

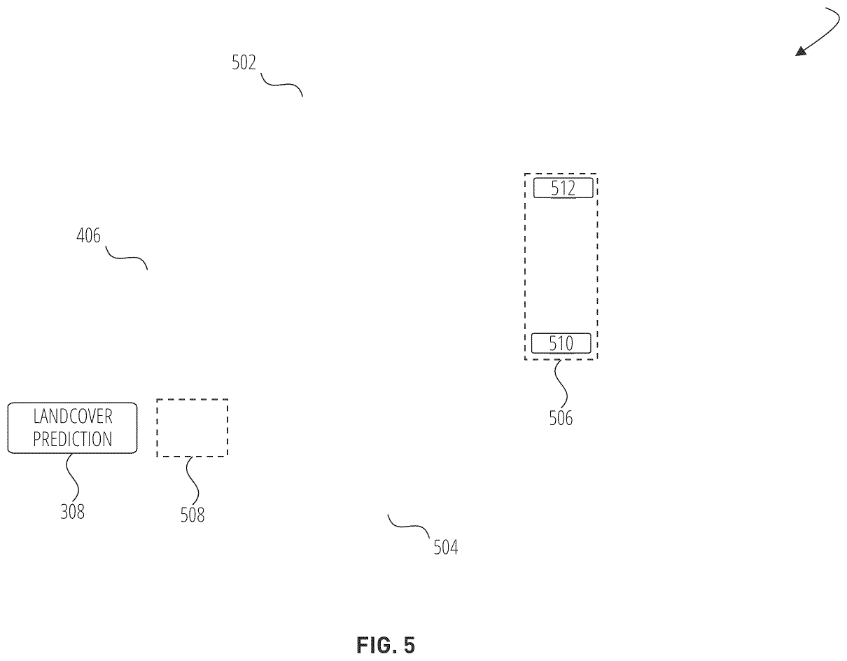

In some embodiments, the machine learning model 410 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning model 410 may be trained to classify one or more portions of a geographic polygon with a landcover prediction 308. The machine learning model 410 may include one or more of any type of machine learning model including one or more supervised, unsupervised, semi-supervised, and/or reinforcement learning models. In some embodiments, the machine learning model 410 may include multiple models configured to perform one or more different stages of an image classification process. For example, as described with reference to FIG. 5, the machine learning model 410, may include one or more machine learning models, such as a feature reduction model and/or a machine learning classification model.

In some embodiments, the one or more machine learning models are previously trained using a plurality of historical hyperspectral image frames that correspond to one or more labeled geographic polygons within one or more geographic regions. The historical hyperspectral image frames, for example, may be stored within one or more image datastores 304. In some examples, the historical hyperspectral image frames may be aggregated with a plurality of landcover labels 404 to generate a labeled training dataset 408 for training the machine learning model 410 and/or a portion thereof.

In some embodiments, the labeled training dataset 408 is a dataset with one or more training input data objects 406. Each training input data object 406, for example, may include historical and/or synthetic georeferenced image data with a corresponding training label. The training label, for example, may describe a target output for the machine learning model 410 (and/or a portion thereof), such as a landcover label 404 for a portion of the georeferenced image data. By way of example, a training input data object 406 may include an image frame (e.g., a hyperspectral image frame, three-channel image frame, etc.) from the image datastore 304. The training label may include a ground truth landcover label for the image frame.

The landcover label 404, for example, may correspond to a three-channel image frame corresponding to a historical hyperspectral image frame (e.g., reduced from, etc.). For instance, the labeled training dataset 408 may include a plurality of landcover labels 404 for a plurality of labeled geographic polygons represented by a plurality of three-channel image frames that correspond with a plurality of historical hyperspectral image frames. In this manner, georeferenced hyperspectral image frames may be used in addition to labeled data indicative of the presence of objects within a geographic region (e.g., on the Earth's surface) to train the machine learning model 410 to leverage dense hyperspectral data to classify the geographic region (e.g., a portion of the Earth's surface). The labeled data, for example, may include geographic polygons labeled with an object class, such as a type of coverage including a type of vegetation species or other type of classification, such as city, road, grassland, and/or the like.

A landcover label 404 may be manually provided by a user (e.g., through the interactive geographic GUI 428, etc.). In addition, or alternatively, a landcover label 404 may include a verified landcover prediction. For example, a landcover prediction 308 that is auto generated by the machine learning model 410 may be automatically and/or manually verified to generate a verified landcover prediction. For instance, a landcover prediction 308 may be verified, using one or more verification models, based at least in part on a comparison between a landcover prediction 308 and contextual data (e.g., land surveys, textual reports, recorded events, etc.) for a geographic polygon corresponding to the landcover prediction. The one or more models, for example, may include one or more language processing models configured to extract landcover-related features from the contextual data. In some examples, the extracted landcover-related features may be compared with a landcover prediction 308 to automatically verify (e.g., if the landcover features are consistent with the landcover prediction 308, etc.) or flag (e.g., if the landcover features are not consistent with the landcover prediction 308, etc.) a landcover prediction 308.

In some examples, a landcover prediction 308 is verified based on user input. For example, the labeled training dataset 408 may be continuously updated online based at least in part on user input. The user input may include landcover labels 404 and/or verifications of landcover predictions 308. The labeled training dataset 408, for example, may continuously receive user input through user interaction with the interactive geographic GUI 428. For example, user interaction provided to a landcover overlay 430 may be leveraged to generate landcover training data, whereas user interaction to transition the overlay to another overlay, such as the carbon stock overlay described herein, may be ignored by the labeled training dataset 408.

In this manner, the machine learning model 410 may be continuously trained and then leveraged to implement one or more automated environment modeling techniques of the present disclosure. As described herein, the machine learning model 410 may include a composite model configured to generate a plurality landcover predictions over one or more stages of a multi-stage image classification process. An example of a multi-stage image classification process will now further be described with reference to FIG. 4.

FIG. 5 is a dataflow diagram showing an example multi-stage image classification process 500 in accordance with some embodiments discussed herein. The multi-stage image classification process 500 includes multiple image processing stages implemented by one or more portions of a machine learning model. A machine learning model, for example, may include a feature reduction model 506 and/or a machine learning classification model 508 that may collectively process a hyperspectral image frame 502 to generate a landcover prediction 308 for a geographic polygon corresponding to the hyperspectral image frame 502.

For example, a hyperspectral image frame 502 may include multi-channel pixel information. In some examples, the multi-channel pixel information of the hyperspectral image frame 502 may be compressed to a more manageable channel representation. For instance, during a channel reduction stage, a three-channel image frame 504 may be generated from the hyperspectral image frame 502.

In some embodiments, the one or more hyperspectral image frames 502 may be input to the feature reduction model 506 to generate the one or more three-channel image frames 504 from the one or more hyperspectral image frames 502. In some embodiments, the feature reduction model 506 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The feature reduction model 506 may include a machine learning model that is trained to generate a three-channel image frame 504 from a hyperspectral image frame 502. For example, the feature reduction model 506 may include an artificial neural network or other feature reduction method that is trained or configured to convert hyperspectral information 510 of the hyperspectral image frame 502 to a three-channel image frame 504 based at least in part on a plurality of annotated image frames. The hyperspectral information 510, for example, may reflect a wide spectrum of light across an electromagnetic spectrum. For instance, the hyperspectral information 510 may include three-dimensional data that represents a pixel's intensity across a plurality of narrow (e.g., 10-20 nm) frequency bands. The three-channel image frame 504 may include three-channel information reflective of a narrow spectrum of light across a visible electromagnetic spectrum (e.g., 400-700 nm), such that the pixels of a three-channel image frame 504 may be represented as a two-dimensional intensity value within a red, blue, and green visible light spectrum.

In some examples, the feature reduction model 506 may include a machine learning model (e.g., neural network, etc.). In some embodiments, the feature reduction model 506 is a layer, sub-model, and/or the like of a composite machine learning model configured to generate a landcover prediction 308 for a geographic polygon. The feature reduction model 506, for example, may be configured to generate a three-channel image frame 504 as an intermediate output for a machine learning classification model 508. In some examples, the feature reduction model 506 and/or the machine learning classification model 508 may be trained end to end.

In some embodiments, the one or more three-channel image frames 504 are input to the machine learning classification model 508 to generate the one or more landcover predictions 308. In some embodiments, the machine learning classification model 508 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning classification model 508 may include a machine learning model that is trained to classify a geographic polygon with a landcover prediction 308. The machine learning classification model 508 may include one or more of any type of machine learning model including one or more supervised, unsupervised, semi-supervised, and/or reinforcement learning models.

In some embodiments, the machine learning classification model 508 includes a machine learning model trained, using one or more supervised training techniques, to generate a landcover prediction 308 for a geographic polygon. The machine learning classification model 508 may include a supervised machine learning model. For example, the machine learning classification model 508 may include one or more classifier models. The one or more classifier models, for example, may include a Support Vector Machine, Naïve Bayes, Logistic Regression, and/or the like. In some examples, the machine learning classification model 508 may include a residual neural network.

In some embodiments, the machine learning classification model 508 may be trained to generate a landcover prediction 308 for a three-channel image frame 504 representing a geographic polygon 314. In some examples, the three-channel image frame 504 may include an intermediate output from the feature reduction model 506. For example, the three-channel image frame 504 may include a reduced-dimensional image that is reduced from an input hyperspectral image. In some examples, the machine learning classification model 508 and the feature reduction model 506 may be jointly trained (e.g., fine-tuned, etc.) to generate landcover predictions 308 from hyperspectral image frames 502.

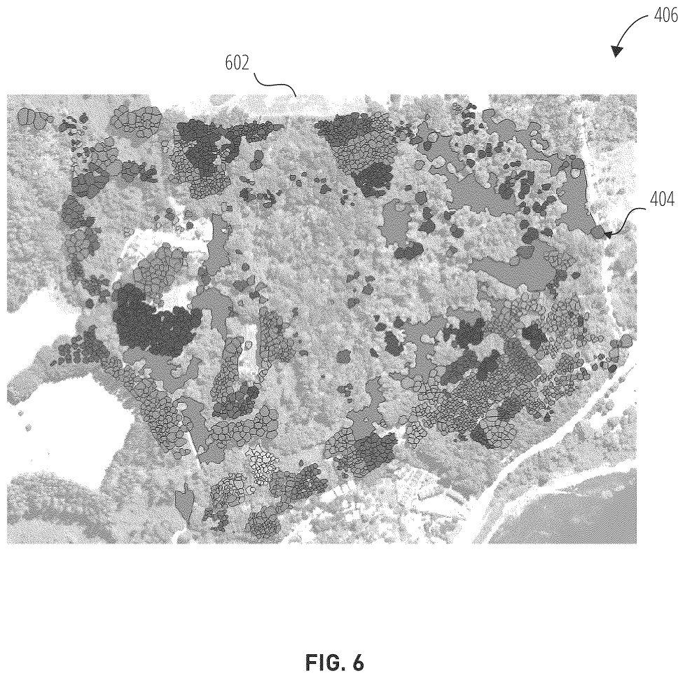

In some embodiments, the machine learning classification model (and/or a composite model) is trained using a labeled training dataset. The machine learning classification model may be updated periodically as the labeled training dataset is generated, received, and/or modified. The labeled training dataset, for example, may include training input data objects 406 that depict one or more landcover labels corresponding to one or more geographic polygons. An example of training input data object 406 will now further be described with reference to FIG. 6.

FIG. 6 is an example training input data object 406 in accordance with some embodiments discussed herein. As depicted, the training input data object 406 may include a historical image 602 (e.g., a three-channel image frame, etc.) that reflects a geographic region with a plurality of geographic polygons. Each of the geographic polygons may include a landcover label 404 indicative of an object class located within a physical location corresponding to the respective geographic polygon. The different landcover labels, for example, are represented by different colors in FIG. 6. The landcover labels 404 may be manually entered and/or predicted by the image processing system 316. In some examples, the landcover labels 404 are input to represent at least a portion of field data conducted by a user.

In some embodiments, user input may be received (and/or provided to), through an interactive geographic GUI that is indicative of the landcover label 404 for a geographic polygon within a geographic region. In some examples, the user input may identify a new object class for a new geographic polygon. For instance, a drawing input may be received through the interactive geographic GUI that is reflective of a geographic polygon within a geographic region. In some cases, a labeling input may be received that corresponds to the geographic polygon and is reflective of an object class for the geographic polygon. In addition, or alternatively, the user input may identify a modification to an existing labeled geographic polygon. For instance, the user input may be reflective of (i) a selection of a mask fitted over the geographic portion (e.g., within a landcover overlay) and/or (ii) a modification to a shape and/or an object class for the geographic portion. In response to the user input, the one or more labeled geographic portions (e.g., georeferenced datapoint, geographic polygons, etc.) within one or more geographic regions may be updated.

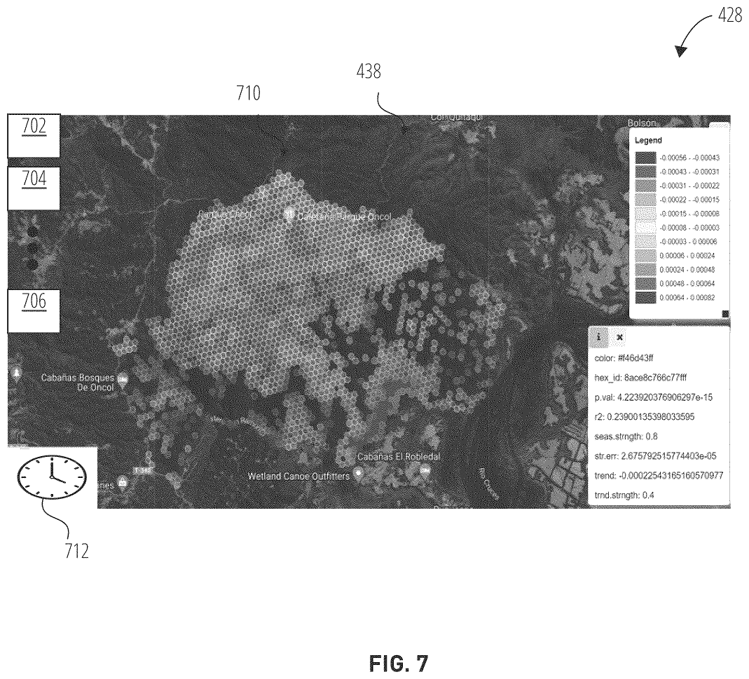

As described herein, various operations of the automated environment modeling technique may leverage and power a new interactive geographic GUI for viewing, manipulating, and processing various geographic insights for an environment. For example, the interactive geographic GUI may be leveraged to receive and generate new training input data objects 406, which may then be used to refine machine learning models configured to generate landcover predictions. Landcover labels and landcover predictions may be presented to a user through one or more overlays of the interactive geographic GUI, which may be interacted with by the user to continuously refine, update, and fine-tune the automated environment modeling techniques described herein. An example of interactive geographic GUI will now further be described with reference to FIG. 7.

FIG. 7 is an example interactive geographic GUI 428 in accordance with some embodiments discussed herein. The interactive geographic GUI 428 includes a map interface 438 with a plurality of selectable overlay icons. In some examples, the presentation of the one or more landcover predictions may be initiated in response to a selection of at least one of the one or more selectable overlay icons. For example, the interactive geographic GUI may include a map interface 438 that reflects a geographic region. The presentation of the one or more landcover predictions may include applying a landcover overlay 430 over the one or more geographic polygons within the geographic region. The landcover overlay may include one or more masks that are fitted to the one or more geographic portions (e.g., georeferenced datapoints, geographic polygons, etc.). For example, the one or more masks may include polygon masks that correspond to one or more geographic polygons. In some examples, each of the one or more polygon masks may reflect an object class corresponding to a respective landcover prediction (and/or landcover label, etc.). As shown in FIG. 7, the one or more polygon masks may include a class-specific indicia (e.g., color, design, text, etc.) that is reflective of an object class corresponding to the respective landcover prediction and/or landcover label for a respective geographic polygon. The polygon mask, for example, may include a visual representation of a landcover label. By way of example, a polygon mask may include a first color for all landcover labels of a first object type (e.g., first tree species, etc.), a second color for all landcover labels of a second object type (e.g., second tree species, etc.), and/or the like.

In some embodiments, the interactive geographic GUI 428 is a graphical user interface provided by a software application, such as the software application provided by the geographic prediction system described herein. The interactive geographic GUI 428 may include a graphical output (that can be rendered by a display coupled to a processing element) and/or one or more input mechanisms (coupled to one or more input devices, etc.) for interacting with a user. For example, the interactive geographic GUI 428 may be a user application, browser, user interface, interface, and/or similar words used herein interchangeably executing on and/or accessible via a user device to interact with and/or cause display of information/data from the geographic prediction system, as described herein.

In some embodiments, the interactive geographic GUI 428 includes a map interface 438 that is rendered by a user device to reflect one or more geographic regions. For example, the graphical output may include a graphical map output that reflects at least one of the one or more geographic regions. The graphical map output may be modified through user input (e.g., a drag input, a pinch input, a double click input, etc.) to view a different geographic region, select a geographic region, and/or the like.

In some embodiments, the interactive geographic GUI 428 renders one or more georeferenced overlays over a geographic region reflected by and/or selected through the map interface 438. For example, the graphical output may include a graphical map output reflective of a geographic region with one or more georeferenced overlays. The one or more georeferenced overlays may include one or more different georeferenced overlays to reflect one or more different perspectives of a geographic region. As examples, the one or more georeferenced overlays may include a landcover overlay icon 702 reflective of one or more object classes physically located within a geographic region, a carbon stock overlay icon 704 reflective of one or more carbon stock values within the geographic region, a species overlay icon 706 reflective of one or more species populations and/or locations within the geographic region, and/or the like.

In some embodiments, a georeferenced overlay corresponds to a particular time or time period. For instance, a geographic region may be associated with a plurality of different georeferenced overlays that change overtime as the physical attributes of the geographic region change. By way of example, an initial landcover overlay may be reflective of a first object class within a geographic region at a first time, whereas a subsequent landcover overlay may be reflective of second object class within the geographic region at a second time after the first object class is removed from the region. In this way, a plurality of sequential georeferenced overlays may be leveraged to generate one or more time lapses indicative of one or more geographical changes within a geographic region over time.

In some embodiments, each georeferenced overlay may be associated with a time parameter that identifies a time (and/or time period) corresponding to a dataset previously leveraged to generate the georeferenced overlay. By way of example, the landcover overlay 430 may be associated with a time parameter that identifies a time corresponding to a plurality of hyperspectral image frames leveraged to generate one or more landcover predictions for the landcover overlay 430, for example, using one or more techniques described herein. As another example, a carbon stock overlay (described herein) may be associated with a time parameter that identifies a time corresponding to one or more landcover predictions leveraged to generate carbon stock predictions for the carbon stock overlay, for example, using one or more techniques described herein.

In some embodiments, the interactive geographic GUI 428 includes one or more selectable icons that enable the interactive display of one or more georeferenced overlays corresponding to one or more time periods. For example, the selectable icons may be rendered within the map interface 438. The selectable icons may include one or more selectable overlay icons and/or timing icons. Each selectable overlay icon may correspond to a respective georeferenced overlay that may be applied over a geographic region reflected by the map interface 438. The timing icons 712 may correspond to a particular time, time period, and/or the like for which at least one georeferenced overlay is available. In some examples, the timing icons 712 may be provided for display in response to a selection of a selectable overlay icon. For example, the one or more selectable overlay icons may include a landcover overlay icon 702 corresponding to a landcover overlay 430, a carbon stock overlay icon 704 corresponding to a carbon stock overlay, a species overlay icon 706 corresponding to a species overlay, and/or the like. In response to the selection of a landcover overlay icon 702, a landcover overlay 430 may be applied to the geographic region of the map interface 438. In some examples, the landcover overlay 430 for a particular time period may be applied to the geographic region of the map interface 438 in response to a selection of a timing icon 712. The landcover overlay 430 may be removed and/or replaced in response to the selection of a different selectable overlay icon and/or timing icon 712. In this manner, a user may toggle between a plurality of different geographic signals from one or more different time periods from one interactive interface.

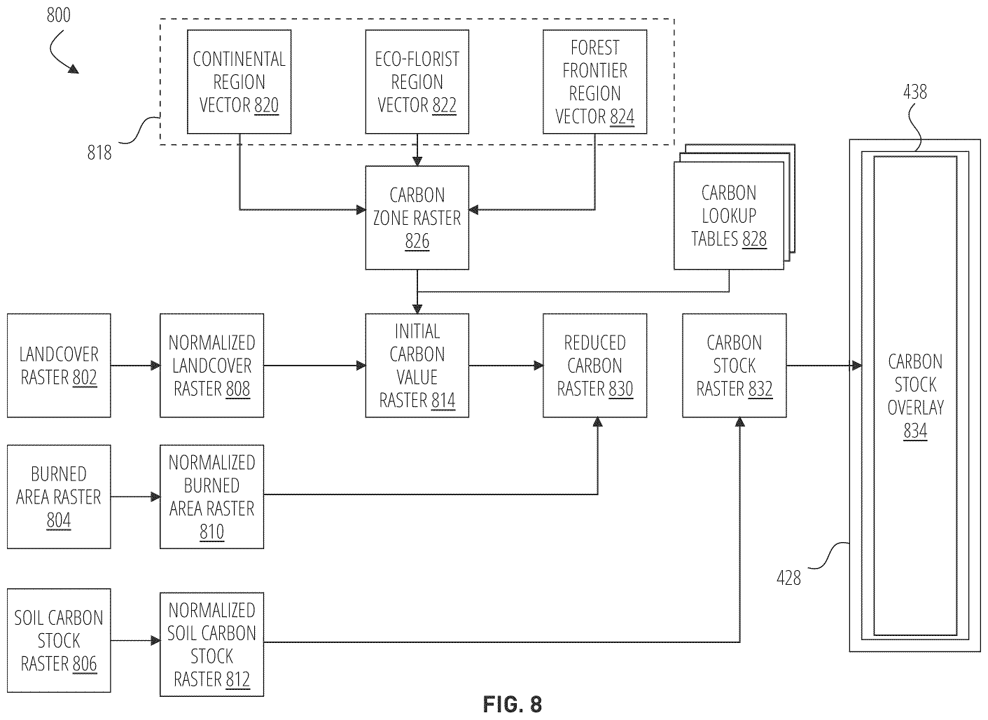

Each of the selectable overlays may provide one or more different geographic insights that are generated using one or more automated techniques of the present disclosure. For example, the landcover overlay 430 provides landcover insight, such as landcover predictions 308, that may be generated using a multi-stage image classification process of the present disclosure. In some examples, another overlay, such as a carbon stock overlay, may be generated based at least in part on the carbon stock value insights. In some examples, the carbon stock value insights may be derived, in part, from landcover predictions. An example carbon classification process will now further be described with reference to FIG. 8.

As indicated above, various embodiments of the present disclosure make important technical contributions to predictive geographical technology. In particular, systems and methods are disclosed herein that implement predictive techniques for automatically generating carbon insights based at least in part on static and dynamic geographic information. Unlike traditional predictive techniques, the carbon classification processes of the present disclosure enable the automatic classification of geographic areas that leverage up to date landcover predictions for the area. This, in turn, allows for the generation of time-dependent carbon-based predictions that are tailored to the features of a geographic region at a particular point in time. Such granular predictions may be compiled and analyzed over time to detect and monitor previously undetectable changes in an environment.

### B. Carbon Stock Predictions

FIG. 8 is a dataflow diagram showing example multi-stage carbon classification process 800 in accordance with some embodiments discussed herein. The multi-stage carbon classification process 800 includes a holistic, automated, and up-to-date carbon stock evaluation scheme for generating a carbon stock raster 832 for a geographic region by augmenting semi-static data, such as global vectors 818 and carbon lookup tables 828, with dynamic data including up to date (or historical) landcover rasters 802, burned area rasters 804, soil carbon stock rasters 806, and/or the like. For example, the plurality of rasters may encode three-dimensional, geo-referenced information for a geographic region. Using some of the techniques of the present disclosure, the rasters may be manipulated, reformatted, augmented, and aggregated over a multi-stage process to generate carbon stock values (e.g., embodied by a carbon stock raster 832) for a geographic region at a particular point in time (e.g., current or historical).

In some embodiments, a carbon stock value is a measurement of a physical location's capacity (e.g., measured, predicted quantity, etc.) to accumulate and/or release carbon. A carbon stock value, for example, may be represented as a number of megagrams of carbon (Mg C) per unit area (e.g., hectare). In some examples, a carbon stock value for a respective geographic region may be based at least in part on a plurality of time dependent factors, such as aboveground biomass (e.g., landcover, etc.), understory vegetation, leaf litter, belowground or root biomass, and/or the like. In some examples, a carbon stock value at a particular geographic point within a geographic region may change over time as the features at the particular geographic point change. As described herein, using some of the techniques of the present disclosure, carbon stock values across a plurality of geographic regions may be continuously refined overtime to represent current carbon stock values as well as changes to carbon stock values over time. Carbon stock values at a particular time, for example, may be represented by the carbon stock raster 832.

As described herein, the carbon stock values for a geographic region may be provided for display by a carbon stock overlay 834 through a map interface 438 presented by an interactive geographic GUI 428. For example, a presentation of the carbon stock raster 832 may be provided (e.g., in response to a selection of the carbon stock overlay icon, etc.) relative to a geographic region. By way of example, as described herein, the interactive geographic GUI 428 (and/or a map interface 438 thereof) may include one or more selectable overlay icons. The presentation of the carbon stock raster 832 may be initiated in response to a selection of a carbon stock overlay icon of the one or more selectable overlay icons. In some examples, the interactive geographic GUI 428 may include a map interface 438 reflective of one or more geographic regions that include the geographic region. In some examples, user input may be received, through the map interface, that is indicative of a selection of a geographic region and the carbon stock overlay 834 may be applied over the geographic region in response to the user input. The carbon stock overlay 834 may include a plurality of pixel values that correspond to the plurality of refined georeferenced carbon datapoints of the carbon stock raster 832.

In some embodiments, the carbon stock overlay 834 is a second type of overlay that may be applied to a geographic region within a map interface 438 provided by the interactive geographic GUI 428. The carbon stock overlay 834 may reflect a plurality of pixel values that respectively correspond to georeferenced carbon datapoints from a carbon stock raster 832. For example, the carbon stock overlay 834 may include a plurality of georeferenced datapoints that identify a pixel value for a georeferenced point within a geographic region. The georeferenced point, for example, may include geographic coordinate (e.g., a latitude and longitude, etc.) and/or a set of geographic coordinates that define a portion (e.g., a geographic polygon, etc.) of a geographic region (e.g., a hectare within the geographic region, etc.). A pixel value may be indicative of a carbon stock value at the georeferenced point. For instance, the pixel value may include an intensity (e.g., grayscale intensity, color intensity, etc.) that is correlated with a carbon stock value corresponding to the georeferenced point. The pixel values of a carbon stock overlay 834 may be fitted over a geographic region to reflect a plurality of carbon stock values within the geographic region at a particular time.

The carbon stock overlay 834 may correspond to a particular time or time period as reflected by a corresponding carbon stock raster 832. A carbon stock raster 832, for example, may be generated for each of a plurality of different time periods through a multi-stage carbon classification process 800. For example, the carbon stock raster 832 may be generated based at least in part on a carbon zone raster 826 and/or one or more dynamic rasters, such as a landcover raster 802, burned area raster 804, soil carbon stock raster 806, and/or the like.

In some embodiments, the carbon zone raster 826 may be received from one or more external computing entities and/or generated based at least in part on one or more global vectors 818. For example, the carbon zone raster 826 may be received for a geographic region based at least in part on a plurality of global vectors 818. The carbon zone raster 826 may be indicative of a plurality of regional features for the geographic regions. For example, the carbon zone raster 826 may include a plurality of georeferenced regional datapoints that are aggregated from a plurality of region classifications for each of the plurality of global vectors 818. The plurality of global vectors 818, for example, may include at least one of a continental region vector 820, an eco-florist region vector 822, and/or a forest frontier region vector 824. In some examples, the plurality of regional features may be indicative of a continental classification, an eco-florist classification, and/or a frontier classification for one or more portions of the geographic region. In some examples, the plurality of global vectors 818 are based at least in part on a selected time parameter.

In some embodiments, a carbon zone raster 826 is a data structure that includes a matrix (e.g., defined by a global coordinate system, etc.) of georeferenced regional datapoints. The carbon zone raster 826, for example, may be indicative of a plurality of regional features for a geographic region. For instance, the carbon zone raster 826 may include a plurality of georeferenced regional datapoints that are aggregated from a plurality of region classifications for each of the plurality of global vectors 818. A georeferenced regional datapoint, for example, may be indicative of a plurality of regional features that correspond to a georeferenced point (e.g., a geographic coordinate, a set of geographic coordinates that define a portion of a geographic region, such as a hectare, etc.). In some examples, the plurality of regional features may include a region classification from each of a plurality of global vectors 818. In some examples, the georeferenced regional datapoint may include a feature code that defines the plurality of regional features. By way of example, each georeferenced regional datapoint of a carbon zone raster 826 may be assigned a code with a value of (i) a continental region classification from a first global vector (e.g., continental region vector 820, etc.), (ii) an eco-floristic region classification from a second global vector (e.g., eco-florist region vector 822, etc.), and/or (iii) a forest frontier region classification from a third global vector (e.g., continental region vector 820, etc.).

In some embodiments, a regional feature is a region classification from a global vector. For example, each respective global vector of a plurality of global vectors may include a respective type of region classifications for a geographic region which may be collectively referred to as regional features. A plurality of regional features may include a plurality of different types of region classifications that are respectively defined by different global vectors. Each regional feature may be indicative of a geographical attribute for at least a portion of a geographic region. By way of example, a regional feature may include one or more of (i) a continental classification that defines a continental region corresponding to at least a portion of a geographic region (e.g., as defined by one or more geographic studies, such as the IPCC Tier-1 Global Biomass Carbon Map, etc.), (ii) an eco-florist classification that defines an eco-floristic zone corresponding to at least a portion of a geographic region (e.g., as defined by one or more geographic studies, such as the United Nations Food and Agricultural Organization, etc.), (iii) a frontier classification that defines a presence of a frontier forest corresponding to at least a portion of a geographic region (e.g., as defined by one or more geographic studies, such as the global frontier forests by the world watch institute, and/or the like.

In some embodiments, the global vectors 818 include data structures that are indicative of a plurality of region classifications for a global environment, such as the earth and/or at least a portion thereof. The global vectors 818 may include any of a plurality of different vectors that may be generated and/or sourced from one or more external data sources. In some examples, the global vectors 818 may include one or more timing parameters that may be indicative of one or more timing characteristics for the vector, such as a validity time period indicative of a time period during which a plurality of region classifications is valid, a source time period indicative of a time at which a plurality of region classifications is generated, and/or the like.

In some embodiments, an initial carbon value raster 814 may be generated for the geographic region based at least in part on the carbon zone raster 826. For instance, the initial carbon value raster 814 may be generated based at least in part on the carbon zone raster 826, a landcover raster 802, and/or a plurality of carbon lookup tables 828. The landcover raster 802 may correspond to a particular time and/or geographic region. For instance, a particular landcover raster 802 may be received for the geographic region that is indicative of a plurality of landcover predictions for the geographic region. In some examples, the landcover raster 802 may be selected from a plurality of landcover rasters for the geographic region based at least in part on a selected time for the carbon zone raster 826. For example, the landcover raster 802 may be based at least in part on a selected time parameter.

In some embodiments, the landcover raster 802 is a data structure that includes a matrix (e.g., defined by a global coordinate system, etc.) of georeferenced landcover predictions and/or landcover classifications as described herein. For example, the landcover raster 802 may be indicative of a plurality of landcover predictions for the geographic region. For instance, the landcover raster 802 may include a plurality of georeferenced landcover predictions corresponding to the geographic region that each include a respective landcover prediction and/or a corresponding georeferenced point. The georeferenced point, for example, may include geographic coordinates (e.g., a latitude and longitude, etc.) and/or a set of geographic coordinates that define a portion of a geographic region (e.g., a geographic polygon, etc.).

In some embodiments, the landcover raster 802 is modified to generate a normalized landcover raster 808 with a resolution corresponding to at least one of the plurality of carbon lookup tables 828.

In some embodiments, the carbon lookup tables 828 include a plurality of carbon values that correspond to one or more geographic features. By way of example, the carbon lookup tables 828 may include a plurality of carbon values that are indexed by at least one of a landcover classification (e.g., object class, etc.), a continental classification, an eco-floristic classification, a frontier classification, and/or the like. By way of example, the carbon lookup tables 828 may include a plurality of carbon lookup tables each of which may correspond to a particular landcover classification. The carbon lookup tables corresponding to a respective landcover classification may include a plurality of carbon values that each correspond to a different combination of continental, eco-floristic, and/or frontier classifications.

In some embodiments, one or more of the carbon lookup tables 828 are associated with a table resolution. For example, the carbon lookup tables 828 may include a plurality of carbon values that correspond to a respective size of geographic area defined by the table resolution. The table resolution, for example, may include a hectare, and/or the like. In some examples, the landcover raster 802 may be aligned with the table resolution (e.g., by scaling the one or more landcover predictions up and/or down, etc.) to generate a normalized landcover raster 808.

In some embodiments, the normalized landcover raster 808 includes a plurality of geographic landcover datapoints for the geographic region. The plurality of geographic landcover datapoints may be generated by scaling the plurality of landcover predictions of the landcover raster 802 based at least in part on the table resolution.

In some embodiments, the normalized landcover raster 808 includes a plurality of landcover classifications that correspond to landcover classifications defined by one or more of the carbon lookup tables 828. By way of example, the landcover raster 802 may include a plurality of landcover predictions. Each of the plurality of landcover predictions may be mapped to at least one of a plurality of landcover classifications defined by one or more of the carbon lookup tables 828.

In some embodiments, the initial carbon value raster 814 includes a plurality of initial georeferenced carbon datapoints that correspond to the geographic region. The plurality of initial georeferenced carbon datapoints, for example, may be generated from the plurality of carbon lookup tables 828, the normalized landcover raster 808, and/or the carbon zone raster 826. The initial carbon value raster may be a data structure that includes a matrix (e.g., defined by a global coordinate system, etc.) of initial georeferenced carbon datapoints corresponding to the geographic region. For instance, the initial carbon stock raster may include a plurality of initial georeferenced carbon datapoints corresponding to the geographic region that each include a respective initial carbon value and a corresponding georeferenced point.

The initial georeferenced carbon datapoints, for example, may be generated based at least in part on a comparison between the normalized landcover raster 808, the carbon zone raster 826, and/or the plurality of carbon lookup tables 828. For example, a regional-landcover pair may be generated for each geographic landcover datapoint of the plurality of geographic landcover datapoints defined by the normalized landcover raster 808. Each geographic landcover datapoint may be generated by matching a geographic landcover datapoint to at least one regional feature of the plurality of regional features from the carbon zone raster 826. A carbon value may be identified, using the plurality of carbon lookup tables 828, for the geographic landcover datapoint based at least in part on the regional-landcover pair. For example, the carbon lookup tables 828 may include at least one carbon value that corresponds to each of a plurality of different regional-landcover pair combinations. In some examples, the plurality of initial georeferenced carbon datapoints defined by the initial carbon value raster 814 may be generated based at least in part on the identified carbon values.

In some embodiments, a reduced carbon raster 830 is generated based at least in part on a comparison between the initial carbon value raster 814 and a burned area raster 804 corresponding to the geographic region. In some examples, the reduced carbon raster 830 includes a plurality of reduced georeferenced carbon datapoints. In some examples, the plurality of reduced georeferenced carbon datapoints are based at least in part on the selected time parameter. For instance, the burned area raster 804 may be based at least in part on a selected time parameter. For example, the burned area raster 804 may be selected, received, and/or generated based at least in part on the selected time parameter. By way of example, the burned area raster 804 may be generated based at least in part on burn reports within a time period of the selected time parameter.

In some embodiments, the reduced carbon raster 830 is a data structure that includes a matrix (e.g., defined by a global coordinate system, etc.) of reduced georeferenced carbon datapoints corresponding to the geographic region. The reduced carbon raster 830, for example, may include a plurality of initial georeferenced carbon datapoints that are modified to account for one or more burned areas within a geographic region. The burned areas, for example, may be accounted for using the burned area raster 804 (and/or a normalized burned area raster 810, etc.).

In some embodiments, the burned area raster 804 is a data structure that includes a matrix (e.g., defined by a global coordinate system, etc.) of georeferenced datapoints. The georeferenced datapoints of the burned area raster 804 may include one or more burned datapoints and/or one or more intact datapoints. In some examples, the burned area raster 804 may be generated based at least in part on one or more historical burn records. By way of example, the one or more burned datapoints may be identified from a plurality of georeferenced datapoints based at least in part on one or more burned areas within a geographic region.

In some embodiments, each of one or more burned datapoints may be indicative of one or more georeferenced points (e.g., a geographic coordinate, a set of geographic coordinates that define a portion of a geographic region, etc.) corresponding to a geographic area that has experienced a burn event (e.g., fire, lightning strike, controlled burn, etc.) within a threshold time period (e.g., of a selected time parameter, etc.). The threshold time period, for example, may be based at least in part on a frequency (e.g., yearly, monthly, etc.) associated with the historical burn records. In some embodiments, each of the one or more intact datapoints may be indicative of one or more georeferenced points corresponding to a geographic area that has not experienced a burn event (e.g., fire, lightning strike, controlled burn, etc.) within the threshold time period.

In some embodiments, each of the burned datapoints and/or intact datapoints include a weighting value and a geographic point. A weighting value, for example, may include a value between zero and one. A weighting value below one may be configured to reduce another value, such as an initial georeferenced carbon datapoint as described herein, when applied to the value. A weighting value that is equal to one may be configured to not impact a value that it is applied to.

In some examples, a weighting value that is below one may be assigned to each burned datapoint identified and corresponding to the geographic region. For instance, the weight value may be 0.5 (and/or any other percentage, such as 0.1, 0.2, and/or the like). The weighting value, for example, may be configured to reduce a value associated with an initial georeferenced carbon datapoint by a predetermined percentage (e.g., 50%, etc.).

In addition, or alternatively, a weight value of one may be assigned to each of the intact datapoints. In this manner, the burned area raster 804 may be applied to an initial carbon value raster 814 to reduce initial georeferenced carbon datapoints that correspond to burned areas, without impacting initial georeferenced carbon datapoints that do not correspond to burned areas.

In some embodiments, the burned area raster 804 is generated for a particular geographic region and/or time period (e.g., based at least in part on the timing parameter) based at least in part on historical burn records for the particular geographic region and/or time period. For example, a geographic raster may be received that corresponds to the geographic region. The geographic raster may include a plurality of georeferenced datapoints. The one or more burned datapoints of the plurality of georeferenced datapoints may be identified that correspond to one or more burned areas within the geographic region. The one or more burned areas may be based at least in part on one or more historical burn records corresponding to the particular geographic region and/or time period. The burned area raster 804 may be generated by assigning a weighting value to each of the one or more burned datapoints.

In some embodiments, a normalized burned area raster 810 is generated based at least in part on a table resolution for the plurality of carbon lookup tables 828. The normalized burned area raster 810 may be generated by scaling the plurality of burned and/or intact datapoints based at least in part on the table resolution. In some embodiments, the reduced carbon raster 830 is generated by applying the normalized burned area raster 810 to the initial carbon value raster 814.

In some embodiments, the carbon stock raster 832 is generated by aggregating the reduced carbon raster 830 with a soil carbon stock raster 806 corresponding to the geographic region. The carbon stock raster 832, for example, may include a plurality of refined georeferenced carbon datapoints corresponding to the geographic region. For example, the soil carbon stock raster 806 may include a plurality of georeferenced soil carbon datapoints. A georeferenced soil carbon datapoint of the plurality of georeferenced soil carbon datapoints may be identified for each of the plurality of reduced georeferenced carbon datapoints of the reduced carbon raster 830. Each refined georeferenced carbon datapoint of the plurality of refined georeferenced carbon datapoints may be generated based at least in part on an addition of a respective georeferenced soil carbon datapoint to a corresponding reduced georeferenced carbon datapoint.

In some examples, the carbon stock raster 832 is generated using a normalized soil carbon stock raster 812. For instance, the normalized soil carbon stock raster 812 may be generated based at least in part on a table resolution for the plurality of carbon lookup tables 828. The normalized soil carbon stock raster 812 may be generated by scaling a plurality of georeferenced soil carbon datapoints based at least in part on the table resolution. In some embodiments, the carbon stock raster 832 is generated by applying the normalized soil carbon stock raster 812 to the reduced carbon raster 830.

In some embodiments, the soil carbon stock raster 806 is a data structure that includes a matrix (e.g., defined by a global coordinate system, etc.) of georeferenced soil carbon datapoints. For example, the soil carbon stock raster 806 may include a plurality of georeferenced soil carbon datapoints that each include a soil carbon value and a georeferenced point (e.g., a geographic coordinate, a set of geographic coordinates that define a portion of a geographic region, such as a hectare, etc.). A soil carbon value, for example, may include a previously recorded carbon value corresponding to the soil located at a respective georeferenced point. By way of example, the soil carbon values may be received from one or more third party sources, such as SoilGrids world layer, and/or the like. In some examples, the soil carbon stock raster 806 may be based at least in part on the selected time parameter as described herein.

In some embodiments, the landcover raster 802, the burned area raster 804, the soil carbon stock raster 806, the carbon zone raster 826, and/or the like may be aligned (e.g., by generating normalized versions thereof) with a lowest resolution layer. By way of example, the soil carbon stock raster 806 may include a resolution of two hundred and fifty meters, the burned area raster 804 may include a resolution of five hundred meters, and/or the landcover raster 802 may include a resolution of three hundred meters. In such a case, each of the rasters (e.g., landcover raster 802, burned area raster 804, etc.) may be aligned with the soil carbon stock raster 806. The rasters may be aligned using various technique including, in some examples, nearest neighbor interpolation and/or the like.

In some examples, at least one of the rasters may be scaled up to a base resolution. For instance, the base resolution may be selected as the lowest resolution layer with respect to the landcover raster 802, the burned area raster 804, the soil carbon stock raster 806. The two rasters with a larger resolution than the base resolution may be scaled down (e.g., using nearest neighbor interpolation, etc.). The carbon zone raster 826 may be scaled down or up to the base resolution. For instance, in the event that the carbon zone raster 826 is associated with carbon lookup table values that are at a resolution of one hundred meters, and the base resolution is a two hundred and fifty meters, the carbon lookup table values may be scaled, using a scaling factor, up to the base resolution.

In some embodiments, the carbon stock raster 832 is a data structure that includes a matrix (e.g., defined by a global coordinate system, etc.) of refined georeferenced carbon datapoints. The carbon stock raster 832, for example, may include a plurality of carbon values that correspond to a geographic region. For instance, the carbon stock raster 832 may include a plurality of refined georeferenced carbon datapoints corresponding to the geographic region that each include a respective carbon value and a corresponding georeferenced point. The georeferenced point, for example, may include geographic coordinate (e.g., a latitude and longitude, etc.) and/or a set of geographic coordinates that define a portion of a geographic region (e.g., a hectare within the geographic region, etc.).

The carbon stock raster 832 may be associated with a timing parameter. In some examples, the timing parameter may be based at least in part on a time period corresponding to one or more input data structures for generating the carbon stock raster 832. By way of example, a carbon stock raster 832 may be generated based at least in part on one or more input rasters, vectors, and/or lookup tables, such as the carbon zone rasters 826, landcover rasters 802, initial carbon value rasters 814, carbon lookup tables 828, reduced carbon rasters 830, burned area rasters 804, soil carbon stock rasters 806, and/or the like, described herein. In some examples, the timing parameter may correspond to a landcover raster 802 and/or any other raster, vector, and/or lookup tables described herein.

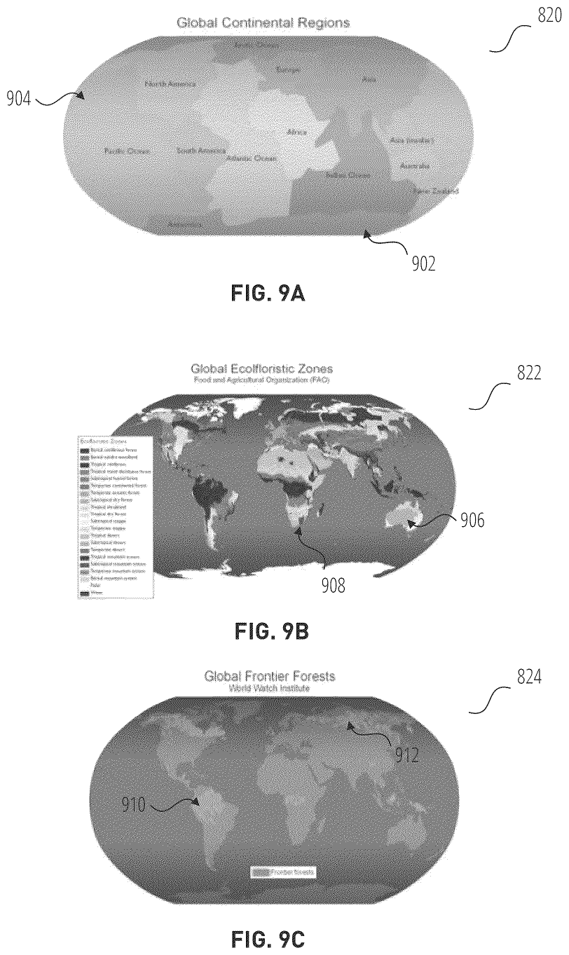

Example input rasters and vectors are illustrated in further detail with respect to FIGS. 9A-C and 10A-C.

FIGS. 9A-C are example global vectors in accordance with some embodiments discussed herein. The global vectors, for example, may each include a plurality of different region classifications that may be represented at a global visibility level. The plurality of region classifications may depend on the type of global vector.

FIG. 9A illustrates a first example global vector that may include a continental region vector 820. The continental region vector 820 may include a plurality of continental classifications 902, 904 for one or more portions of a global environment. By way of example, the continental region vector 820 may include an IPCC Tier-1 Global Biomass Carbon Map.

FIG. 9C illustrates a second example global vector that may include an eco-florist region vector 822. The eco-florist region vector 822 may include a plurality of eco-florist classifications 906, 908 for one or more portions of a global environment. By way of example, an eco-florist region vector 822 may include a global map of global eco-floristic zones mapped by the United Nations Food and Agricultural Organization.

FIG. 9A illustrates a third example global vector that may include a forest frontier region vector 824. In some examples, forest frontier region vector 824 may include a plurality of frontier classifications 910, 912 for one or more portions of a global environment. By way of example, the forest frontier region vector 824 may include locations of frontier forests (e.g., which are likely to be over twenty years old, relatively undisturbed by humans, and largely shaped by natural forces) as defined by the WorldWatch Institute, and/or the like.

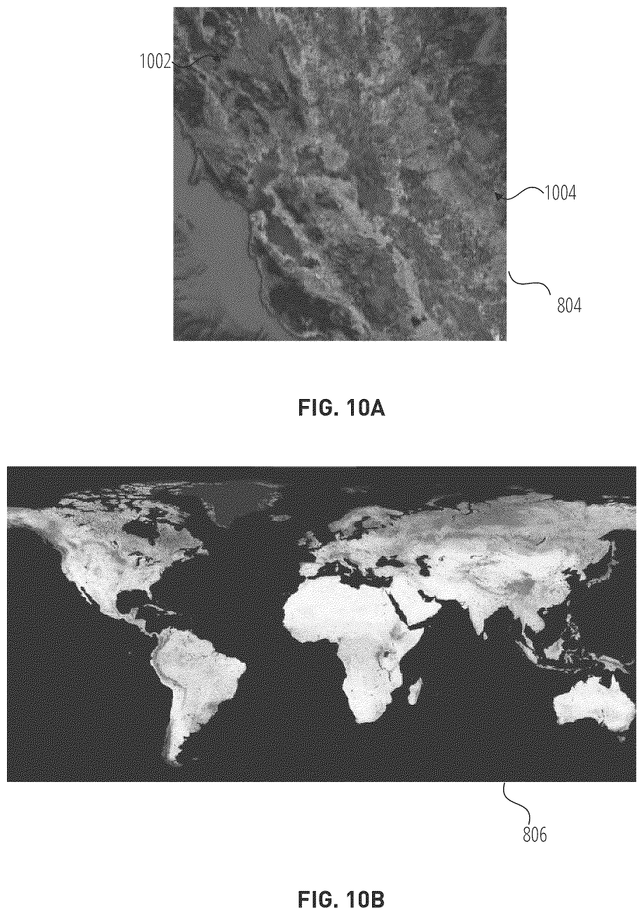

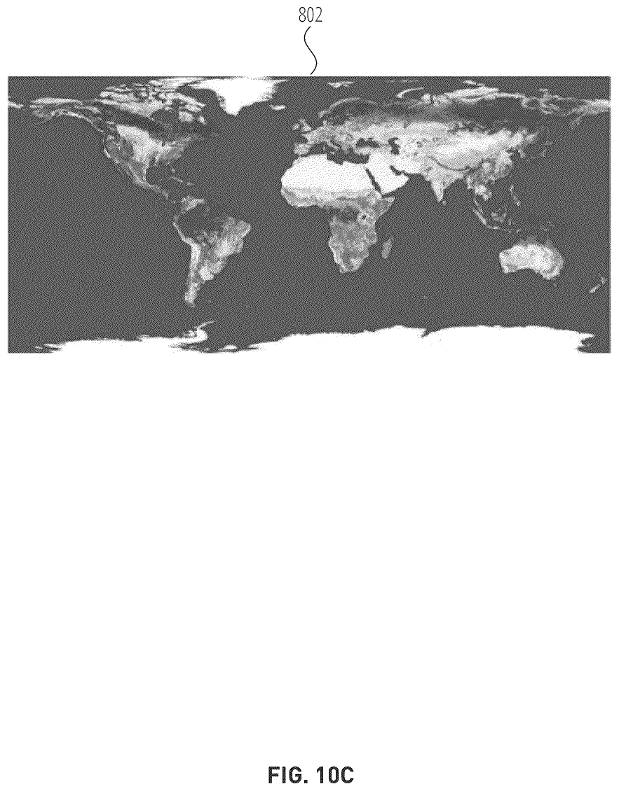

FIGS. 10A-C are example input rasters in accordance with some embodiments discussed herein. The input rasters, for example, may each include a plurality of georeferenced classifications that may be represented at a global visibility level and/or geographic region level. The plurality of georeferenced classifications may depend on the type of global vector.

FIG. 10A illustrates a first example input raster that may include a burned area raster 804. As described herein, the burned area raster 804 may include a plurality of burned datapoints 1002 and/or intact datapoints 1004 for one or more portions of an environment.

FIG. 10B illustrates a second example input raster that may include a soil carbon stock raster 806. As described herein, the soil carbon stock raster 806 may include a plurality of soil carbon stock values for one or more portions of an environment. In some examples, the soil carbon stock raster 806 may include carbon stock values for a global environment. The soil carbon stock value may be represented as color intensities, as shown in FIG. 10B.

FIG. 10C illustrates a third example global vector that may include a landcover raster 802. As described herein, the landcover raster 802 may include a plurality of landcover classifications, such as landcover predictions, for one or more portions of an environment. In some examples, the landcover raster 802 may include landcover classifications for a global environment. The landcover classifications may be represented as color intensities, as shown in FIG. 10C.

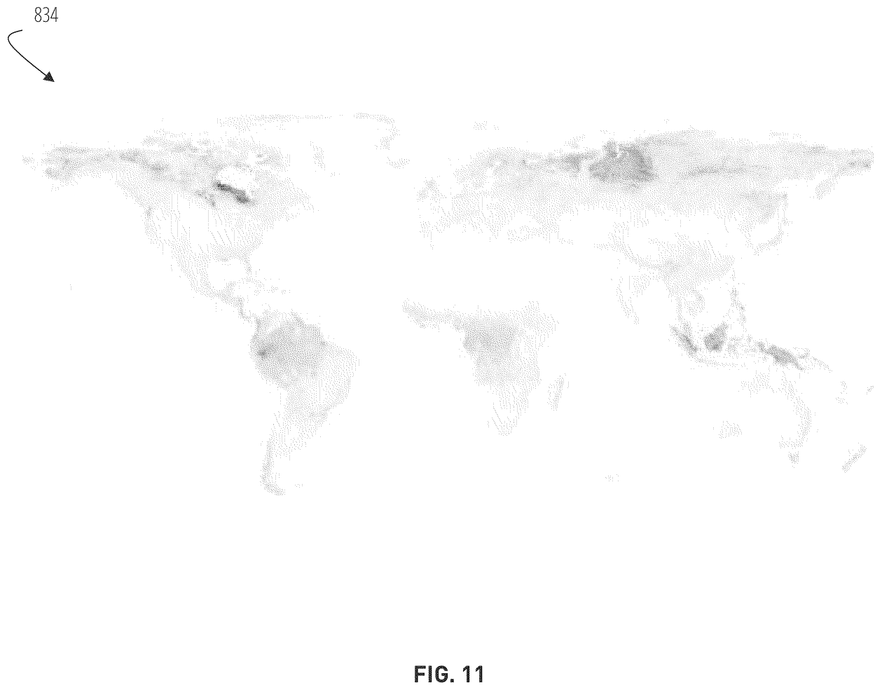

FIG. 11 is an example carbon stock overlay 834 in accordance with some embodiments discussed herein. As described herein, an interactive geographic GUI that may include one or more selectable icons that enable the interactive display of one or more georeferenced overlays corresponding to one or more time periods. In some examples, a carbon stock overlay 834 may be presented in response to a selection of carbon stock overlay icon. The carbon stock overlay 834 may include a plurality of carbon stock values for one or more portions of an environment. In some examples, the carbon stock values may include values for a global environment, as depicted. The landcover classifications may be represented as color intensities, as shown in FIG. 11.

### C. Species Statistical Distribution

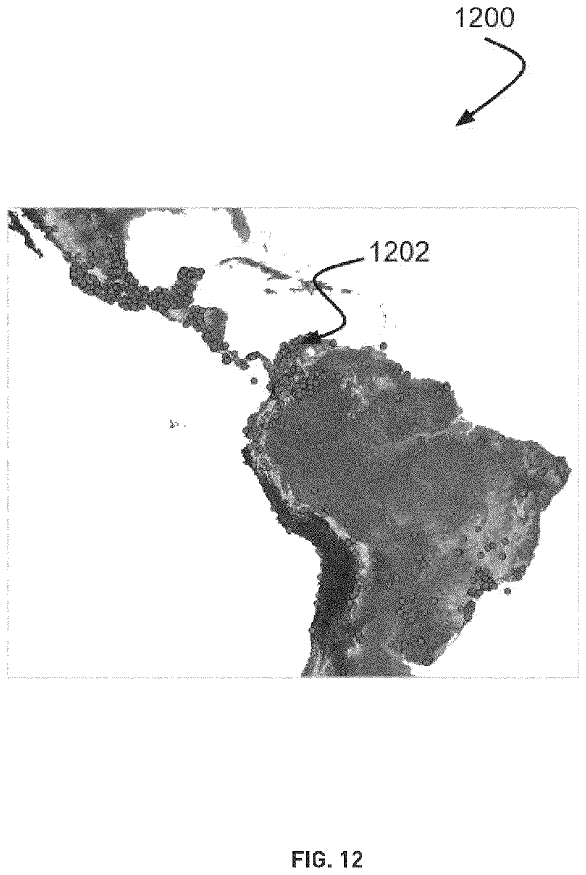

FIG. 12 is an example species overlay 1200 in accordance with some embodiments discussed herein. As described herein, an interactive geographic GUI that may include one or more selectable icons that enable the interactive display of one or more georeferenced overlays corresponding to one or more time periods. In some examples, a species overlay 1200 may be presented in response to a selection of species overlay icon.

In some embodiments, the species overlay 1200 is a third type of overlay that may be applied to a geographic region. The species overlay 1200 may reflect a plurality of pixel values that respectively correspond to georeferenced species datapoints indicative of a species population at a respective georeferenced point. For example, the georeferenced species datapoints may be based at least in part on species occurrences 1202 for a geographic region.

In some embodiments, a species overlay includes a species richness index and/or a statistical estimation of species distribution. In some examples, statistical models may be applied to predicted species richness and distribution for any target species. For example, species occurrences 1202 data may be aggregated for a target species. The species occurrences data may include georeferenced data labeled with a type of species detected. These detections or occurrences may be location-specific sightings (with associated location data, such as GPS coordinates), detections obtained in studies using camera traps (with associated location data), and/or others. In addition, or alternatively, environmental data may be received. The environmental data may include one or more georeferenced environmental rasters indicative of one or more environmental variables such as height, type of climate, and/or water availability within a geographic region. In some embodiments, a location-based statistical model may be leveraged to generate a species distribution model 1202 based at least in part on the species occurrences data and/or the environmental data. The location-based statistical model may be configured to receive, as input, location data identifying a single location associated with a particular species and raster data identifying regions relevant for particular species or identifying regions of particular climate characteristics that may be correlated to a particular species. The location-based statistical model may utilize one or more reduction models to reduce the dimensionality of each input type such that the model can ingest multiple input types for a machine-learning based analysis of the data. The resulting output may provide geographic data (e.g., predictions) for various species based at least in part on the location-based statistical model. For example, species distribution 1200 for one or more geographical locations may be based at least in part on the location-based statistical model.

### D. Example Methods

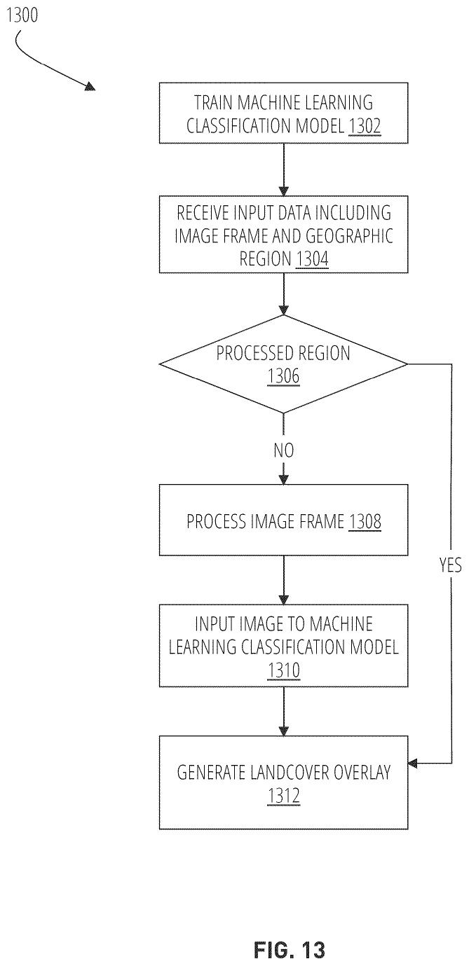

FIG. 13 is a flowchart showing an example of a process 1300 for generating one or more landcover predictions in accordance with some embodiments discussed herein. The flowchart depicts a multi-stage image classification process for generating a predictive output from a combination of disparate data sources to overcome various limitations of traditional landcover prediction techniques. The multi-stage image classification process may be implemented by one or more computing devices, entities, and/or systems described herein. For example, via the various steps/operations of the process 1300, the computing system 100 may generate, leverage, and retrain a machine learning model capable of leveraging insights from both hyperspectral and three-channel image data to overcome various limitations (e.g., accuracy, comprehensiveness, lack of automation, etc.) with traditional landcover prediction techniques. By way of example, unlike traditional landcover prediction techniques, the machine learning model may be capable of synthesizing features extracted from multiple hyperspectral image frames with user input provided through three-channel image frames.

FIG. 13 illustrates an example process 1300 for explanatory purposes. Although the example process 1300 depicts a particular sequence of steps/operations, the sequence may be altered without departing from the scope of the present disclosure. For example, some of the steps/operations depicted may be performed in parallel or in a different sequence that does not materially impact the function of the process 1300. In other examples, different components of an example device or system that implements the process 1300 may perform functions at substantially the same time or in a specific sequence.

In some embodiments, the process 1300 includes, at step/operation 1302, training a machine learning classification model. For example, the computing system 100 may train the machine learning classification model during a training stage. In some examples, the machine learning classification model may be tailored to a particular prediction, such as a landcover prediction, for a geographic region and/or portion thereof. In addition, or alternatively, the machine learning model may be configured (e.g., using an ensemble architecture, etc.) to generate multiple predictions for the geographic region and/or portion thereof. The model may be trained using a training dataset including data defined by a plurality of distinct datatypes. For instance, the training dataset may include a plurality of three-channel image frames, hyperspectral image frames, species sightings, among other data types, such as those described herein.

In some embodiments, the training dataset includes an image data store. During the training stage, an image datastore, such as a hyperspectral image database, may be accessed to receive one or more hyperspectral image frames for a geographic region. In addition, or alternatively, field information may be accessed for the geographic region. The hyperspectral image frames may be labeled (e.g., manually, using one or more rule-based techniques, etc.), using the field information, to generate training data, such as a landcover training database, that includes a plurality of labeled image frames labeled with landcover labels. In some examples, the landcover training database may include a plurality of labeled three-channel image frames that are reduced from the hyperspectral image frames. The machine learning classification model may be trained, using one or more supervised training techniques such as backpropagation of errors, and/or the like, to generate landcover predictions that correspond to the landcover labels of the labeled image frames.

In some embodiments, the training process includes aggregating training data from across a plurality of multiple data types to enable the processing of multiple data types simultaneously. In some examples, weights may be assigned to one or more of the data types based on supervisory data (e.g., manual labels, etc.). As an example, ground truth labels provided within three-channel image frames may be aggregated with corresponding hyperspectral image frames (e.g., using feature reduction techniques, etc.).

In some examples, the training dataset may include a plurality of image frames that correspond to one or more different fields of view. For example, the machine learning classification model may receive a plurality of different types of image frames as input including, as examples, image frames that correspond to single GPS coordinate (e.g., species sightings, etc.), image frames that correspond to a large geographic region (e.g., satellite image data, etc.), and/or the like. In some examples, the computing system 100 may distinguish different data types of images (e.g., through image classification, feature reduction, and/or the like) and/or labels thereof to assign one or more weights, embeddings, vectors, and/or the like that encode and/or contextualize information reflected by a data type. In this manner, the machine learning classification model may be trained to generate predictions based at least in part on multiple types of images, data types, and/or the like.

In some embodiments, the process 1300 includes, at step/operation 1304, receiving input data including an image frame and/or a geographic region. For example, the computing system 100 may receive user input that is indicative of a geographic region and/or a portion (e.g., geographic polygon thereof). In addition, or alternatively, the computing system 100 may receive an image frame. The image frame, for example, may include a hyperspectral image frame captured by a geospatial satellite. In some examples, the computing system 100 may receive one or more hyperspectral image frames corresponding to at least a portion of the geographic region.

In some embodiments, the process 1300 includes, at step/operation 1306, determining whether the geographic region is a processed region with a corresponding landcover label. For example, the computing system 100 may access a landcover dataset to determine whether a geographic region is stored with a landcover label within the landcover dataset. In the event that the geographic region corresponds with a landcover label, the process 1300 proceeds to step/operation 1312 where the process 1300 generates a landcover overlay using the landcover label. In the event that the geographic region does not correspond with a landcover label, the process 1300 proceeds to step/operation 1308.

In some embodiments, the process 1300 includes, at step/operation 1308, processing the image frame corresponding to the geographic region. For example, the computing system 100 may process the image frame corresponding to the geographic region. In some examples, the computing system 100 may preprocess the image frame, using one or more noise reduction techniques, to refine the image frame (e.g., the hyperspectral information thereof). In some examples, the hyperspectral information may be extracted from the image frame and the spectra may be preprocessed, by a feature reduction model, to generate a three-channel image frame from the image frame.

In some embodiments, the process 1300 includes, at step/operation 1310, inputting the image frame (and/or a derivative thereof) to the machine learning classification model. For example, the computing system 100 may input the three-channel image frame to the machine learning classification model. The machine learning classification model may generate a landcover prediction for the geographic region and/or a portion thereof (e.g., a geographic polygon, etc.) based at least in part on the three-channel image frame. In this manner, the computing system 100 may generate, using one or more machine learning models, one or more landcover predictions for the geographic region based at least in part on the one or more hyperspectral image frames. In some examples, the one or more landcover predictions correspond to one or more geographic polygons within the geographic region. In some examples, the one or more machine learning models are previously trained (e.g., during the training stage) using a plurality of historical hyperspectral image frames that correspond to one or more labeled geographic polygons within one or more geographic regions.

In some embodiments, the process 1300 includes, at step/operation 1312, generating a landcover overlay for the geographic region. For example, the computing system 100 may generate the landcover overlay for the geographic region based at least in part on the landcover prediction. In some examples, the computing system 100 may initiate, through an interactive user interface, a presentation of the landcover prediction to a user, for example, using the landcover overlay.

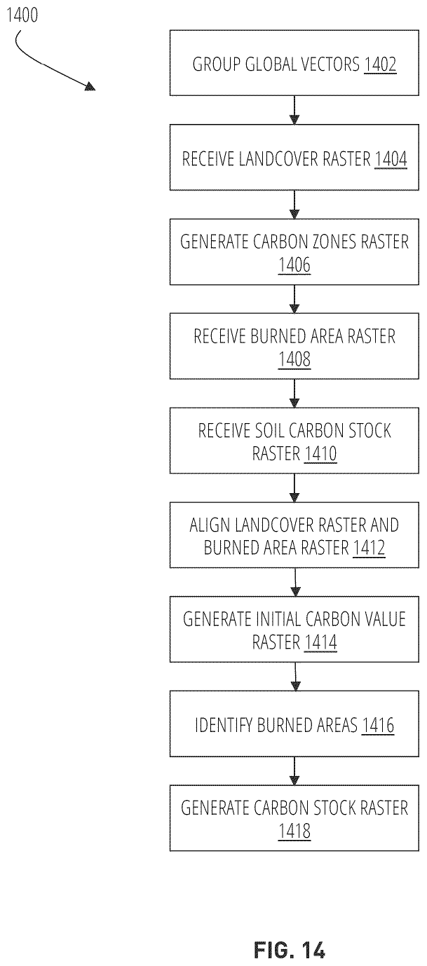

FIG. 14 is a flowchart showing an example of a process 1400 for generating one or more carbon stock values in accordance with some embodiments discussed herein. The flowchart depicts a multi-stage carbon classification process for generating a predictive output from a combination of static and dynamic data to overcome various limitations of traditional carbon prediction techniques that are limited to static and in field observations. The classification process may be implemented by one or more computing devices, entities, and/or systems described herein. For example, via the various steps/operations of the process 1400, the computing system 100 may generate, leverage, and present time dependent carbon stock rasters that are capable of leveraging insights from real-time and historical inputs to overcome various limitations (e.g., accuracy, comprehensiveness, lack of automation, etc.) with traditional carbon value estimation techniques. By way of example, unlike traditional carbon value estimation techniques, the carbon stock rasters may synthesize features extracted from customizable input rasters, such as landcover rasters, burned area rasters, soil carbon stock rasters, and/or the like, with historical knowledge derived from global vectors and lookup tables.

FIG. 14 illustrates an example process 1400 for explanatory purposes. Although the example process 1400 depicts a particular sequence of steps/operations, the sequence may be altered without departing from the scope of the present disclosure. For example, some of the steps/operations depicted may be performed in parallel or in a different sequence that does not materially impact the function of the process 1400. In other examples, different components of an example device or system that implements the process 1400 may perform functions at substantially the same time or in a specific sequence.

In some embodiments, the process 1400 includes, at step/operation 1402, grouping global vectors. For example, the computing system 100 may group the global vectors. The plurality of global vectors may include at least one of a continental region vector, an eco-florist region vector, and/or a forest frontier region vector. Each of the global vectors may include a plurality of regional features that are indicative of at least one of a continental classification, an eco-florist classification, and/or a frontier classification for one or more portions of a geographic region.

In some embodiments, the process 1400 includes, at step/operation 1404, receiving a landcover raster. For example, the computing system 100 may receive the landcover raster. For instance, the computing system 100 may receive a landcover raster for the geographic region. The landcover raster may be indicative of a plurality of landcover predictions for the geographic region. In some examples, the landcover raster may be aligned with a table resolution corresponding to a plurality of carbon lookup tables.

In some embodiments, the computing system 100 selects a landcover raster. The computing system 100 may map landcover classes to be used according to a plurality of carbon lookup tables. In some examples, the computing system 100 may scale carbon value according to a desired raster resolution. For example, the values of the carbon lookup tables may be determined to one hectare, such that they must be dimensioned depending on the resolution of the final raster.

In some embodiments, the process 1400 includes, at step/operation 1406, generating carbon zones raster. For example, the computing system 100 may generate the carbon zones raster. For example, the computing system 100 may generate and/or receive the carbon zone raster for a geographic region based at least in part on a plurality of global vectors. The carbon zone raster may be indicative of a plurality of regional features for the geographic region. The carbon zone raster may include a plurality of georeferenced regional datapoints that are aggregated from a plurality of region classifications for each of the plurality of global vectors.

In some embodiments, the computing system 100 generates a carbon zone raster at a soil carbon stock raster resolution. For instance, each pixel may be assigned a code with a value of continental region, eco-floristic region, and/or forest frontier region.

In some embodiments, the process 1400 includes, at step/operation 1408, receiving a burned area raster. For example, the computing system 100 may receive the burned area raster. For instance, the computing system 100 may receive a raster of burned areas within a time period, such as a year, to be calculated.

In some embodiments, the process 1400 includes, at step/operation 1410, receiving a soil carbon stock raster. For example, the computing system 100 may receive the soil carbon stock raster, such as a SoilGrids world layer.

In some embodiments, the process 1400 includes, at step/operation 1412, aligning the landcover and burned area rasters. For example, the computing system 100 may align the landcover and burned area rasters. In some examples, the computing system 100 may align the landcover and burned area rasters to a soil carbon stock raster resolution. The landcover raster, for example, may be aligned to 300 m to 500 m. The burned area raster may be aligned to 250 m from 500 m.

In some embodiments, the process 1400 includes, at step/operation 1414, generating an initial carbon value raster. For example, the computing system 100 may generate the initial carbon value raster. For instance, the computing system 100 may generate an initial carbon value raster for the geographic region based at least in part on the landcover raster, the carbon zone raster, and a plurality of carbon lookup tables. The initial carbon value raster may include a plurality of initial georeferenced carbon datapoints corresponding to the geographic region.

In some embodiments, the initial carbon value raster may include a plurality of predicted aerial carbon values. The raster may be generated by assigning values of carbon tables according to codes of continental region, eco-floristic region, and/or forest frontier region existing in the carbon zone raster and the normalized landcover raster.

In some embodiments, the process 1400 includes, at step/operation 1416, identifying burned areas. For example, the computing system 100 may identify the burned areas. In some examples, the computing system 100 may identify the burned areas based at least in part on the burned area raster. The burned area raster may be pre-processed by changing pixels with no data values to one and pixels with values to 0.5. In some examples, the burned areas raster and the initial carbon value raster may be multiplied to decrease the carbon value by 50% in some areas of a geographic region. In some embodiments, the computing system 100 may generate a reduced carbon raster based at least in part on a comparison between the initial carbon value raster and the burned area raster corresponding to the geographic region.

In some embodiments, the process 1400 includes, at step/operation 1418, generating a carbon stock raster. In some embodiments, the computing system 100 may generate a carbon stock raster by aggregating the reduced carbon raster with a soil carbon stock raster corresponding to the geographic region. For example, the computing system 100 may generate the carbon stock raster by adding the reduced carbon raster together with the soil carbon stock raster. The carbon stock raster may include a plurality of refined georeferenced carbon datapoints corresponding to the geographic region. In some embodiments, the computing system 100 may initiate, through an interactive user interface, a presentation of the carbon stock raster relative to the geographic region.

### V. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A geographic prediction system comprising memory and one or more processors communicatively coupled to the memory, the one or more processors configured to:
receive one or more hyperspectral image frames corresponding to at least a portion of a geographic region;
generate, using one or more machine learning models, one or more landcover predictions for the geographic region based at least in part on the one or more hyperspectral image frames, wherein:
(i) the one or more landcover predictions correspond to one or more geographic portions within the geographic region, and
(ii) the one or more machine learning models are trained using at least a plurality of historical hyperspectral image frames that correspond to one or more labeled geographic portions within one or more geographic regions; and
initiate, through an interactive user interface, a presentation of the one or more landcover predictions to a user.

2. The geographic prediction system of claim 1, wherein the one or more processors are further configured to:
receive, through the interactive user interface, user input indicative of a selection of at least one of the one or more geographic portions within the geographic region; and
generate, using the one or more machine learning models, the one or more landcover predictions for the geographic region in response to a determination that the at least one geographic portion is an unlabeled geographic portion.

3. The geographic prediction system of claim 1, wherein the interactive user interface comprises one or more selectable overlay icons and the presentation of the one or more landcover predictions is initiated in response to a selection of at least one of the one or more selectable overlay icons.

4. The geographic prediction system of claim 1, wherein a geographic portion of the geographic region comprises a geographic polygon or a georeferenced datapoint within the geographic region.

5. The geographic prediction system of claim 4, wherein the geographic polygon comprises a closed geographic area within the geographic region and a landcover prediction for the geographic polygon is indicative of an object class physically located within the closed geographic area.

6. The geographic prediction system of claim 5, wherein the object class is one or more of a type of vegetation species or a type of geographic environment.

7. The geographic prediction system of claim 1, wherein the interactive user interface reflects the geographic region and initiating the presentation of the one or more landcover predictions to the user comprises:
applying a landcover overlay over the one or more geographic portions within the geographic region and the landcover overlay comprises one or more masks that are fitted to the one or more geographic portions.

8. The geographic prediction system of claim 7, wherein the one or more geographic portions comprise one or more geographic polygons, the landcover overlay comprises one or more polygon masks that are fitted to the one or more geographic polygons, and each of the one or more polygon masks reflect an object class corresponding to a respective landcover prediction.

9. The geographic prediction system of claim 7, wherein each of the one or more masks comprises a class-specific color reflective of the object class corresponding to the respective landcover prediction.

10. The geographic prediction system of claim 1, wherein the one or more processors are further configured to:
receive, through the interactive user interface, user input indicative of a landcover label for a geographic portion within the geographic region; and
in response to the user input, update the one or more labeled geographic portions within the one or more geographic regions.

11. The geographic prediction system of claim 10, wherein the user input is reflective of (i) a selection of a mask fitted over the geographic portion and (ii) a modification to a shape or an object class for the geographic portion.

12. The geographic prediction system of claim 11, wherein receiving, through the interactive user interface, the user input indicative of the landcover label for the geographic portion within the geographic region comprises:
receiving, through the interactive user interface, a drawing input reflective of a geographic polygon; and
receiving, through the interactive user interface, a labeling input reflective of an object class for the geographic polygon.

13. The geographic prediction system of claim 1, wherein generating the one or more landcover predictions comprises:
inputting the one or more hyperspectral image frames to a feature reduction model to generate one or more three-channel image frames from the one or more hyperspectral image frames; and
inputting the one or more three-channel image frames to a machine learning classification model to generate the one or more landcover predictions.

14. A computer-implemented method, the computer-implemented method comprising:
receiving, by one or more processors, one or more hyperspectral image frames corresponding to at least a portion of a geographic region;
generating, by the one or more processors and using one or more machine learning models, one or more landcover predictions for the geographic region based at least in part on the one or more hyperspectral image frames, wherein:
(i) the one or more landcover predictions correspond to one or more geographic portions within the geographic region, and
(ii) the one or more machine learning models are trained using at least a plurality of historical hyperspectral image frames that correspond to one or more labeled geographic portions within one or more geographic regions; and
initiating, by the one or more processors and through an interactive user interface, a presentation of the one or more landcover predictions to a user.

15. The computer-implemented method of claim 14, further comprising:
receiving, through the interactive user interface, user input indicative of a selection of at least one of the one or more geographic portion within the geographic region; and
generating, using the one or more machine learning models, the one or more landcover predictions for the geographic region in response to a determination that the at least one geographic portion is an unlabeled geographic polygon.

16. The computer-implemented method of claim 14, wherein the interactive user interface comprises one or more selectable overlay icons and the presentation of the one or more landcover predictions is initiated in response to a selection of at least one of the one or more selectable overlay icons.

17. The computer-implemented method of claim 14, wherein a geographic portion of the geographic region comprises a geographic polygon or a georeferenced datapoint within the geographic region.

18. The computer-implemented method of claim 17, wherein the geographic comprises a closed geographic area within the geographic region and a landcover prediction for the geographic polygon is indicative of an object class physically located within the closed geographic area.

19. The computer-implemented method of claim 18, wherein the object class is one or more of a type of vegetation species or a type of geographic environment.

20. A computer program product comprising a non-transitory computer readable medium having computer program instructions stored therein, the computer program instructions when executed by one or more processors, cause the one or more processors to:
receive one or more hyperspectral image frames corresponding to at least a portion of a geographic region;
generate, using one or more machine learning models, one or more landcover predictions for the geographic region based at least in part on the one or more hyperspectral image frames, wherein:
(i) the one or more landcover predictions correspond to one or more geographic portions within the geographic region, and
(ii) the one or more machine learning models are trained using at least a plurality of historical hyperspectral image frames that correspond to one or more labeled geographic portions within one or more geographic regions; and
initiate, through an interactive user interface, a presentation of the one or more landcover predictions to a user.
